(19) United States
(12) Patent Application Publication
(10) Pub. No.: US 2004/0030572 A1
(43) Pub. Date: Feb. 12, 2004

(54) Same day product and document delivery management system and process

(76) Inventors: Helen Campbell, Arlington, VA (US); Jerry Kozelsky, Silver Spring, MD (US); Oscar A. Valenzuela, Burke, VA (US); Joseph Kopeck, McLean, VA (US)

Correspondence Address: DICKSTEIN SHAPIRO MORIN & OSHINSKY LLP, 2101 L STREET NW, WASHINGTON, DC, 20037-1526, US

(21) Appl. No.: 10/428,838

(22) Filed: May 5, 2003

Related U.S. Application Data
(63) Continuation of application No. 60/377,233, filed on May 3, 2002.

(51) Int. Cl. G06F 17/60; G01C 21/26

(52) U.S. Cl. 705/1; 701/202

(57) ABSTRACT

A method and system for performing routed deliveries in a highly efficient manner enables both senders and recipients, as appropriate, to monitor relevant delivery routes and track the delivery progress in real time, access delivery summary reports, and manage invoices. Using the system, a same-day on-demand delivery order may be placed by phone or through a web site. A dispatch processor determines a branch server to handle the delivery order and transmits the order to the branch server. If an acknowledgement of the order is not received within a designated amount of time, an alarm is sounded. Upon receipt of the order at the branch server, a dispatch server assigns the delivery order to a driver to perform the delivery. The system also manages operation of same-day large-scale routed deliveries. For routed deliveries, couriers are assigned delivery routes which enable optimized efficiency in performing the routed delivery order in that the delivery stops are automatically placed in the most efficient sequence using a pre-designed, optimized route (e.g. destination address of each stop, travel directions to each stop from the previous stop). For each type of delivery, the courier provides delivery status information status in real time to a branch server as each delivery is made, which enables customers and recipients to track parcel delivery and monitor routes in real time through a web site.

### FIELD OF THE INVENTION

The invention relates generally to a business method and system for the same day delivery of documents and packages based on orders placed both on demand and as routed work.

### BACKGROUND OF THE INVENTION

With the advent of the Internet, more and more businesses have been expanding to reach not only national, but also international markets. At the same time, technological advances have also increased productivity and efficiency so that faster service, greater efficiency, greater effectiveness, and more customized solutions are becoming the expected norm. This increase in customer-oriented solutions has also had a positive impact on business-to-business transactions, as companies are working together more to provide solutions to customers' needs. One industry benefiting from such growth is the delivery service industry, which provides a vital link in the flow of business-to-business and business-to-consumer commerce.

Although many types of delivery services are available through both the U.S. Postal Service and any of numerous commercial delivery service providers (“DSPs”), the services available may be generally categorized into local and non-local deliveries, on-demand services and scheduled services, and routed and non-routed deliveries. Local deliveries are deliveries in which both the origination and destination points are in the same local area, and the same facility generally handles the delivery from start to finish. Delivery times for local deliveries generally range from 20 minutes to 3 hours. Non-local deliveries require a package or document (hereinafter “parcel”) to be shipped long distance, and are managed via a hub-and-spoke system. Packages are deposited at special collection centers or may be picked up directly from the sender, depending on volume. They are then transferred to a local sorting center where they are recorded, sorted and shipped by road or air to the sorting center nearest to their destination. When they arrive at the destination sorting center, they will be recorded, sorted and dispatched to a driver who will make the final delivery to the recipient. The time of delivery and name of the recipient will often be recorded (although this information may not be available for some hours after the event). Delivery times generally range from 15 hours to 3 days.

On-demand deliveries are performed on an ad-hoc basis, with the sender initiating the delivery by placing an order with the DSP to immediately begin the delivery process. Scheduled deliveries have prearranged pickup and delivery times at predetermined locations, and may take place on a recurring basis.

Routed delivery service is generally performed pursuant to a prior agreement between the sender and the DSP, where the sender has a bulk shipment of parcels to be delivered to a large number of recipients, typically all within the same local area. Non-routed deliveries include all other deliveries which are not contractually prearranged or which do not require delivery to a large number of recipients.

Some DSPs may specialize in same-day courier services, in which a sender requires a parcel to be delivered that same day. Such same-day deliveries may include on-demand, scheduled or routed services. In the case of same day on-demand deliveries, the courier will pick up the parcel from the sender and transport it directly to its destination. The itinerary of the driver is not set at the beginning of the day, and is substantially determined by incoming delivery orders as they are received throughout the day. In contrast, same-day scheduled deliveries are deliveries with a predetermined pickup and delivery destination that take place regularly on a particular day of the week at a particular time.

Routed same-day deliveries involve large numbers of deliveries and may be static (meaning the same addresses are visited every time) or dynamic (meaning that the set of addresses visited may vary). The DSP receives the parcels from the sender, records and sorts them and then dispatches a driver to deliver them. There may be several thousand parcels involved in a routed delivery order. Moreover, the parcels may not be available for sorting and processing by the DSP prior to the day of delivery, and may not be packaged with the specialized containers, envelopes or labels required by DSPs. These factors present major operational hurdles for the DSP in that the parcels require a significant amount of time to sort by hand, assign for delivery, and to track the progress of delivery. If the delivery order is time critical with only a few hours from the time the DSP receives the parcels to the time by which they must be delivered, and/or if the delivery order involves very large numbers of parcels with many delivery stops, the situation is likely to be beyond the capabilities of the DSP to process. Further, in the case of dynamic routes, it is usually left to the driver to decide how to organize the stops on the route. While a driver who normally covers a particular geographic area may have learned the most efficient way of traversing the route, if that driver is unavailable, a substitute driver is unlikely to be able to make the deliveries as efficiently and therefore be unable to meet the required delivery times.

Another challenge for DSPs is that the pace of society continues to quicken alongside the development of technology, with the result that both senders and recipients have come to expect increased efficiency and greater access to information regarding the status of deliveries. At best, some DSPs can only provide tracking information as to what day a parcel is estimated to arrive, and only offer time-stamped tracking updates at transfer locations at major distribution hubs, and the time of delivery several hours after the delivery has already been made.

### BRIEF SUMMARY OF THE INVENTION

The present invention provides a method and system for performing both on demand and routed same-day deliveries in a highly efficient manner and which enables both senders and recipients, as appropriate, to monitor relevant delivery routes and to track the delivery progress of each individual package in real time, access delivery summary reports, and manage invoices. In the method, an on-demand delivery order may be placed by phone or through a web site. A dispatcher assigns the delivery order to a driver to perform the delivery. The courier can transmit full delivery details to the DSP and its systems using wireless text-enabled mobile phones.

Delivery information for routed deliveries may also be provided to the DSP by electronic transmission via data interchange (such as XML data), a tab delimited file, or an Excel® file, or may be entered into the DSP's systems by matching a unique client and address identifier on a package with a database record. For routed deliveries, delivery stops are automatically placed in the most efficient sequence using a pre-designed, optimized route (e.g. destination address of each stop, travel directions to each stop from the previous stop). A dispatcher checks the availability of the driver assigned to the route and then transmits the delivery information (e.g. recipient name, contact name, special instructions, etc.) for the entire route to the driver at the same time. Alternatively, the dispatcher may transmit information about only the initial few stops and leave it to the driver to electronically access further information through a wireless communication device as needed.

Parcel tracking and route monitoring are performed in real time on all deliveries, including on-demand and routed deliveries, by entering a time stamped update and the name of the person signing for the receipt of each parcel directly to the DSP's operational management system using wireless text-enabled mobile phones. Such updated tracking and route status information is immediately viewable by both the sender and the recipient(s) through either the DSP's web site, the sender's web site and/or a partner web site jointly maintained by the DSP and the sender. The sender can view not only the updated tracking and route status information, but also analyses and reports of deliveries made, and account management information through a secure portion of the partner web site.

These and other features and advantages of the invention will be more apparent from the following detailed description, which is provided in connection with the accompanying drawings and illustrate exemplary embodiments of the invention.

### BRIEF DESCRIPTION OF THE DRAWINGS

FIG. 1 is a flow chart illustrating the operational process of managing a same day routed delivery request in accordance with a first aspect of the present invention;

FIG. 2 is a diagram illustrating a management and operating system for performing the same day routed delivery request in accordance with the first aspect of the present invention;

FIG. 3 illustrates an exemplary screen for entering a single route order in accordance with an exemplary embodiment of the invention;

FIG. 4 illustrates an exemplary screen for creating a printed delivery manifest for route drivers in accordance with an exemplary embodiment of the invention;

FIG. 5 is an exemplary format in which a delivery manifest for a route may be printed;

FIG. 6 shows an exemplary home page of a partner web site according to the present invention;

FIG. 7 shows an exemplary page of the partner web site of FIG. 5 used to track a delivery or set of deliveries for a specified client;

FIG. 8 shows an exemplary page of the partner web site of FIG. 5 displaying a list of delivery jobs for a specified client;

FIG. 9 shows an exemplary page of the partner web site of FIG. 5 in which a set of delivery jobs is selected to be tracked according to a key word of a client name and specified time period;

FIG. 10 shows an exemplary page of the partner web site of FIG. 5 displaying a list of clients having the key word shown in FIG. 8 in the name;

FIG. 11 shows an exemplary page of the partner web site of FIG. 5 displaying a list of delivery jobs for a client selected from the list shown in FIG. 9;

FIG. 12 shows an exemplary page of the partner web site of FIG. 5 displaying detailed information about a selected delivery job from the list shown in FIG. 10;

FIGS. 13A and 13B show an exemplary page of the partner web site of FIG. 5 for monitoring the routes containing stops for delivery jobs ordered by the sender;

FIG. 14 shows an exemplary page of the partner web site of FIG. 5 for monitoring the general performance of the delivery operations;

FIG. 15 shows an exemplary page of the partner web site of FIG. 5 displaying a chart of deliveries made within a specified time period with information as to whether or not the deliveries were made on time;

FIG. 16 shows an exemplary page of the partner web site of FIG. 5 displaying a graph for demonstrating the overall variation in the timeliness of the deliveries made of the specified time period;

FIG. 17 shows an exemplary page of the partner web site of FIG. 5 displaying a graph for demonstrating the overall timeliness of the deliveries made over the specified time period, relative to the contracted delivery time;

FIG. 18 shows an exemplary page of the partner web site of FIG. 5 for selecting a delivery report to be viewed for a specified time period;

FIG. 19 shows an exemplary page of the partner web site of FIG. 5 displaying a chart demonstrating the general time frames of deliveries made over the specified time period;

FIG. 20 shows an exemplary page of the partner web site of FIG. 5 displaying a chart of the total number of deliveries made during the specified time period;

FIG. 21 shows an exemplary page of the partner web site of FIG. 5 displaying a graph of the total number of deliveries made during the specified time period;

FIGS. 22A-22B show an exemplary page of the DSP's web site for placing an on-demand delivery order;

FIG. 23 shows an exemplary page of the DSP's web site for entering in address information for pickup and delivery in connection with on-demand order placed using the exemplary page shown in FIGS. 22A-22B;

FIG. 24 shows an exemplary error message alerting a user that an incorrect address was entered in the exemplary page shown in FIG. 23, together with suggestions for correcting the errors;

FIG. 25 shows an exemplary page of the DSP's web site viewed by a user upon completion of entering an order using the exemplary pages shown in FIGS. 22A-22B and 23;

FIG. 26 shows an exemplary page of the DSP's web site which provides the user with options for printing labels for the parcel(s) to be delivered;

FIG. 27 is a flow chart illustrating the operational process of managing a same-day on-demand delivery order in accordance with a second aspect of the present invention;

FIG. 28 is a diagram illustrating a system for managing an on-demand delivery order in accordance with the second aspect of the present invention;

FIG. 29 is an exemplary page of the DSP's intranet site displaying financial management and report information;

FIG. 30A is an exemplary page of the DSP's web site through which users can track a parcel delivery;

FIG. 30B is an exemplary page of the DSP's web site showing tracking information for a parcel tracked using the exemplary page shown in FIG. 30A; and

FIGS. 31A-31B show an exemplary page of the DSP's web site through which users can request to view a report of their deliveries performed by or to be performed by the DSP.

### DETAILED DESCRIPTION OF THE INVENTION

The present invention provides a system and method for managing same-day routed deliveries and same-day on-demand deliveries. Although the description which follows describes the same-day routed deliveries separately from the same-day on-demand deliveries, the two aspects of the invention are not necessarily mutually exclusive. For example, various features of the system will be discussed below as pertaining more particularly to either routed deliveries or to on-demand deliveries. However, the overall system and method of the present invention encompasses elements all of the elements discussed below with respect to all disclosed aspects of the invention, including the management and operation of delivery services which combine features of routed and on-demand services. Thus, it should be understood that the exemplary system and method of the present invention are merely illustrative of the different functions of the present invention, and should not be interpreted as limiting the invention to the specific structural arrangements and process flows disclosed below.

According to a first aspect of the present invention, the system and method manages and performs a same-day, large-scale routed delivery operation in which a customer (the sender) contractually arranges with the DSP to deliver a large number of parcels originating from the same location, and in which a list of potential delivery recipients has previously been made known to the DSP by the sender. To facilitate such deliveries, the DSP develops a database of recipients (i.e. the customer's customers or clients), their addresses and preferred delivery times. In this database, each client and address is associated with a unique identifier preferably corresponding with the unique identifier used by the customer within its systems. Moreover, the database is structured so that a particular client may be associated with more than one address. The DSP may receive address and client information from its customers in electronic form, or in paper form, which requires the data to be manually entered into the DSPs's client database. Any address and client information received from the customers is processed through a series of “data cleansing” routines at the DSP location to normalize the address information to USPS standard format, and to make any necessary corrections before uploading it into the database.

The corrected address information is used to derive the most efficient set of routes for performing the customer's routed deliveries, taking into account the “deliver by” times contracted by the customer, using specially designed route logistics management software. Each route is a detailed itinerary specifying the order in which the designated stops along the route are to be made, along with directions indicating the optimized roads or streets between each stop. Since the routes are structured to ultimately take into account the amount of time needed to arrive at each stop, the number of stops along a route may vary from route to route. Once the routes have been designed, the route number and sequence number within the route is added to the address information. Optionally, a driver may also be assigned to the route.

The pre-population of the DSP's client database, the address correction, and the route generation for each customer is performed prior to any deliveries being made for the customer. Since an optimized route may lose efficiency over time due to events such as construction projects, increased developments, changes in traffic flow patterns through a geographical region, etc., the optimized routes may be tested and re-optimized on a periodic basis. Also although the optimized routes may be substantially predetermined for each customer prior to the performance of each same-day route delivery operation, the present invention maintains the capability to revise delivery routes as necessary to accommodate unexpected changes as they occur.

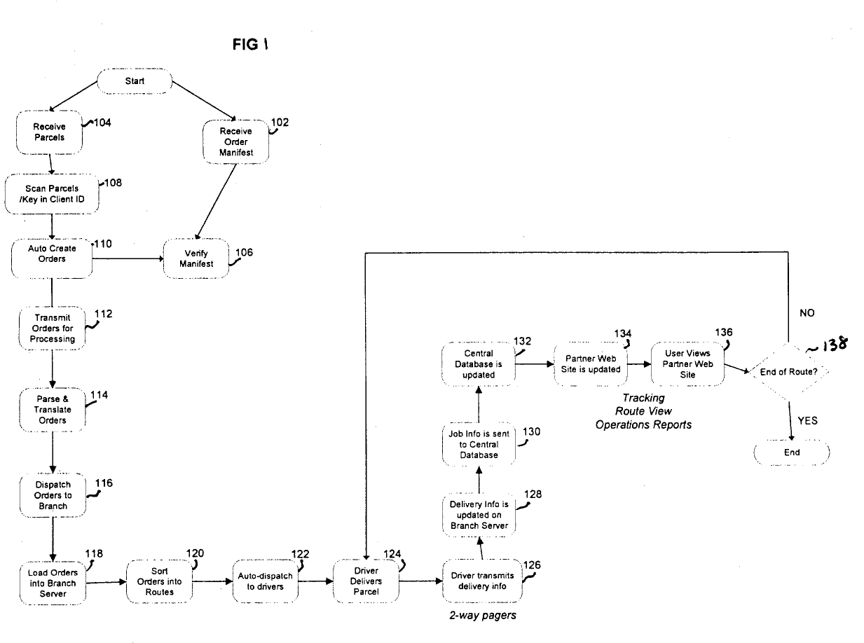

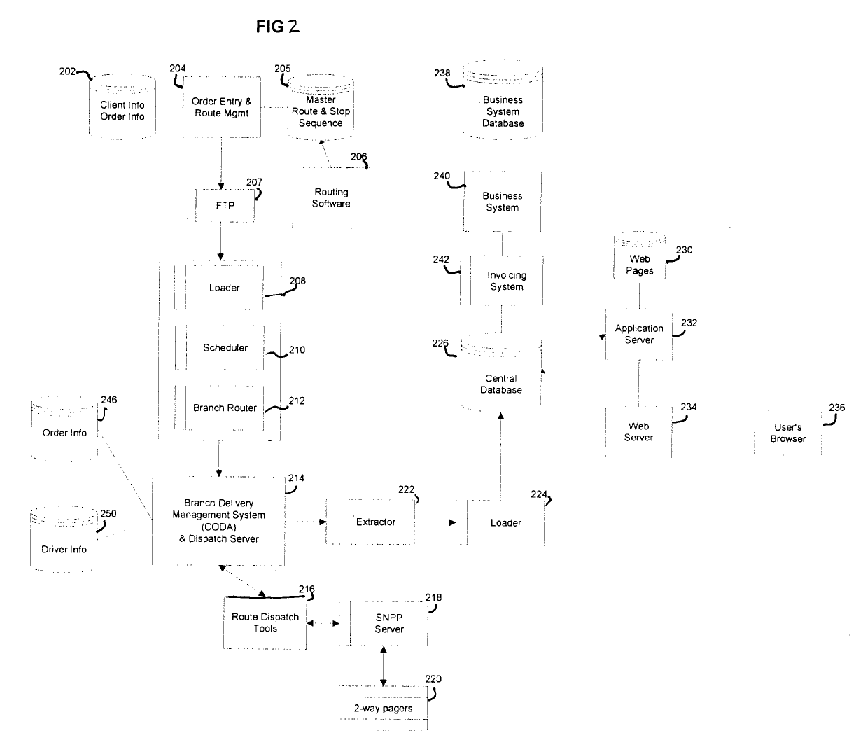

FIG. 1 shows an exemplary embodiment of the method according to the first aspect of the present invention, which generally outlines the process 100 performed in the execution of a same day routed delivery order, and FIG. 2 shows an exemplary system 200 for managing the routed deliveries and other operations processes.

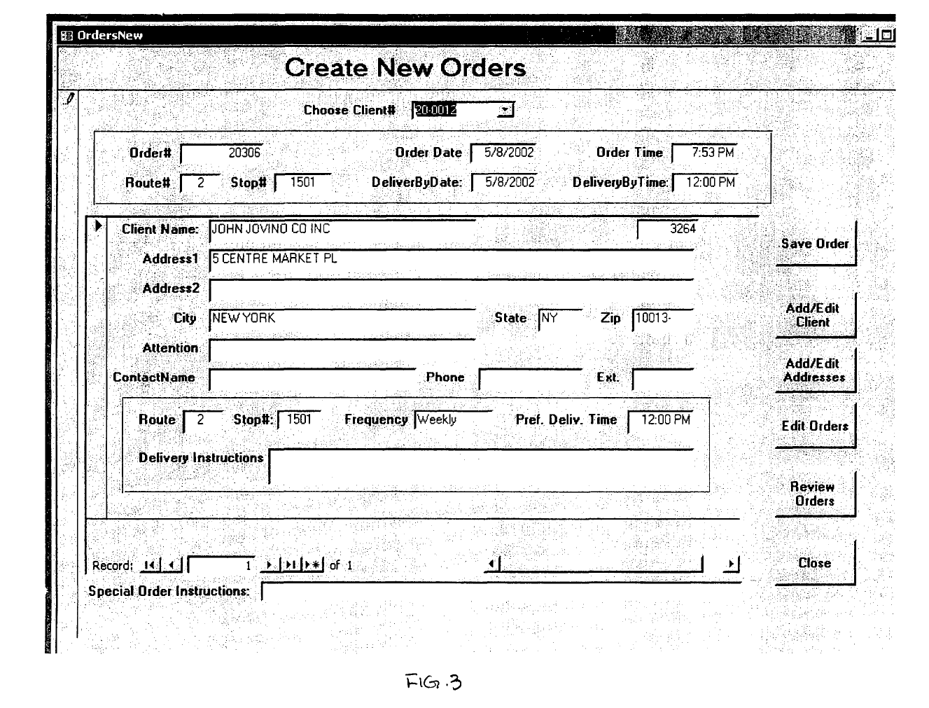

As represented by process segment 104, the DSP may collect the parcels to be route delivered from the customer's warehouse and line-haul them back to the DSP's facility, or the customer may deliver the parcels directly to the DSP's facility. The customer may also provide a manifest in electronic format inventorying the parcels to be delivered, as shown at process segment 102. Once at the DSP's facility, if the parcels are each labeled with a barcode which uniquely identifies both the recipient and the address, they will be scanned (process segment 108). Order entry and route management module 204 (FIG. 2) uses the client and address identifier to automatically create a delivery order for each parcel at process segment 110, whereupon the delivery orders are then stored in the order database 202 (FIG. 2). No further data entry by the DSP's personnel is required. An example of an order entry screen used in connection with this procedure is shown in FIG. 3. In particular, the order is created automatically on entry of the client ID in the appropriate field. Entry of the client ID information can be accomplished by direct data entry, menu selection or scanning of the barcode on the parcel. This order entry process offers significant advantages over the prior art delivery process in which a human operator would be required to read each package, key in the address and order information and then sort the packages by rough geographic area. If the parcels are not bar-coded, or if the barcodes do not uniquely identify a delivery address within the DSP's database, the DSP's route operator will key in the client identifier and select the address that matches the one on the parcel from among the plurality of addresses listed for the client (process segment 108). Since no specific packaging or labeling is required by the DSP, packaging costs are reduced for the sender.

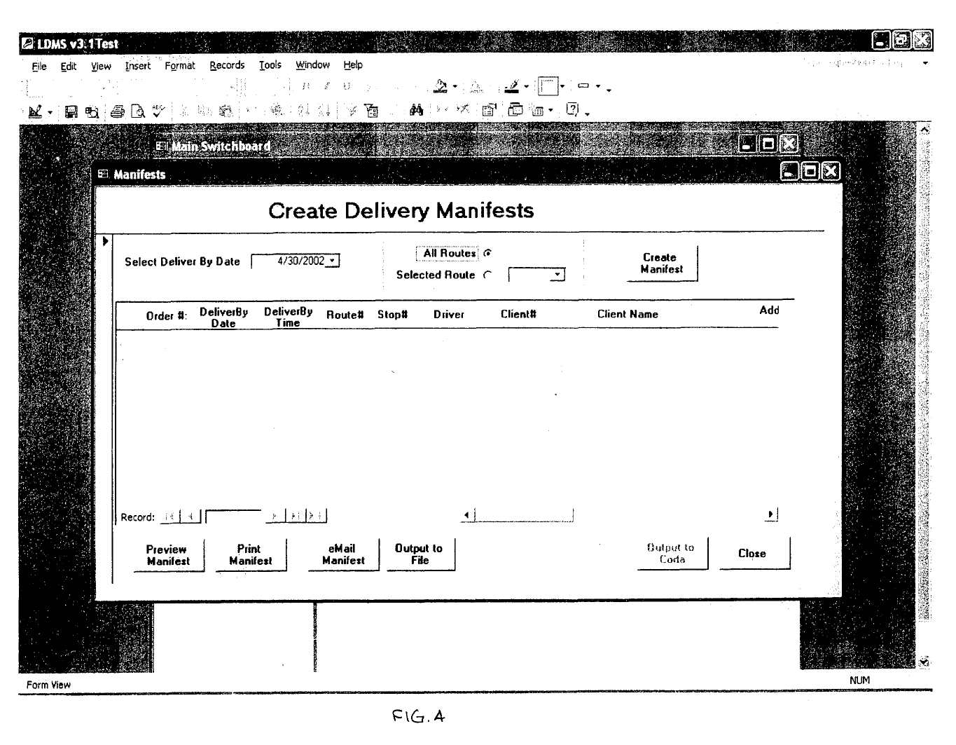

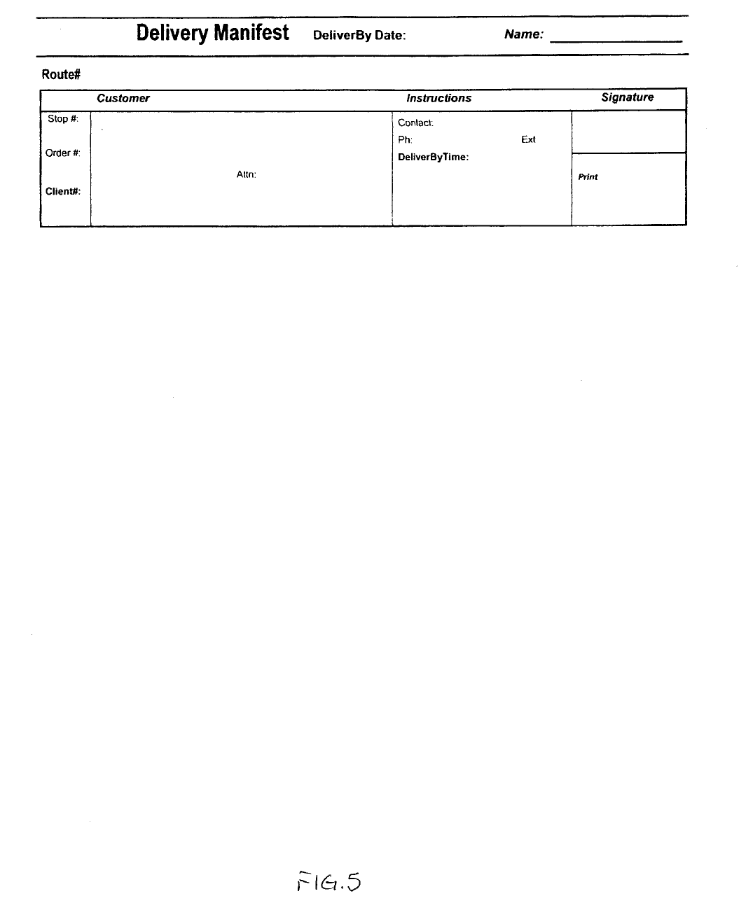

Once all the orders have been created, printed delivery manifests for each route can be rapidly produced, using the route and stop number associated with each address. FIG. 4 shows an exemplary screen for creating printed manifests and FIG. 5 provides an example of one such manifest. If the customer has provided an electronic delivery manifest, this can be reconciled with the orders entered in the DSP's order management system so that the customer can be notified of any discrepancies in number between parcels listed on the manifest and actual parcels received by the DSP (process segment 106). Delivery manifests may be provided by the customer in XML, comma delimited or Excel® file formats. In each case, a set of processing routines converts the customer manifest into a form which can be compared with the newly entered delivery orders.

Next, the generated orders stored in database 202 are transmitted for processing via FTP module 207 at process segment 112, together with historical route data (including information pertaining to optimized routes generated by routing software 206) contained in the master route and stop sequence database 205. The orders are separated into recognizable pieces of delivery information for each recipient/stop at process segment 114, and each stop is assigned a corresponding tracking number in the DSP's system. The order information is transmitted to loader module 208 and then to scheduler module 210 and branch router 212, which queues the orders ready for transmission to the branch and dispatch server 214. Once received by the branches' delivery order management system (branch and dispatch server) 214, the orders are posted to the pending board ready for dispatch (process segment 116).

The scheduler 210 times the routing of the orders so that the branch and dispatch server 214 only receives the order information when the routes are ready to be dispatched. Since dispatch can be automatic when received by the branch and dispatch server 214, if the parcels are received and processed the evening before they are to be delivered, for example, the scheduler serves to hold the orders from being sent through the router 212 and subsequently posted for dispatch before the assigned driver is available to deliver the route the next morning.

If the DSP has multiple branch locations associated with the facility at which the parcels are processed, the branch router 212 also serves to route the orders to the appropriate branch locations at process segment 116, so that parcel and associated delivery information is received by the branch location most local to the respective route. The order information is then loaded into the respective branch and dispatch server 214 at process segment 118. The branch and dispatch server 214 includes a dedicated dispatch system which serves and manages the dispatch tools software 216 on each dispatcher's desk top. The branch and dispatch server 214 are supported by an array of datastores including a database of driver information 250 and order information 246.

In the prior art delivery process, it was often not possible to make use of dispatch systems to manage large-scale routes because each order would have to be individually assigned to a driver and the delivery details individually conveyed. DSPs had to rely on paper-based methods, which are error prone and result in deliveries being missed or delayed. In the current invention, information about all the stops on a route can be sent automatically as a whole to the designated driver. All the human dispatcher needs to do is to confirm that the designated driver is available, and using the route dispatch software 216, he or she is able to assign all the deliveries in a route at the same time and transmit the entire route manifest electronically to the driver using wireless enabled text-messaging (process segment 122). Each driver is equipped with a text and voice enabled bi-directional wireless communication device 220, e.g., Nextel® wireless telephones/pagers, so that delivery information, special instructions, changes in instructions, etc. can be passed on from the dispatch processor 216 to the driver en route via the communication server (“SNPP”) 218. Alternatively, the system can be set to allow drivers to “self-serve” delivery information from their route-assignments, by downloading detailed delivery from the order manifest onto their respective communication devices 220 as required. In either case, once the route is “dispatched” to an assigned driver, the process of monitoring deliveries is automatic and the dispatcher can concentrate on resolving any difficulties that may arise.

At process segment 124, the drivers deliver the parcels in accordance with their assigned routes. Where required, the communication devices 220 may include scanner units either integrally formed as part of the communication device or as an attachment thereto for reading all types of bar code labels and transmitting the bar code information to the branch server 214 via the communication device. The communication device provides time-stamped feedback to the branch server 214 (through the communication server 218 and dispatch processor 216) indicating whether the driver has received and read the delivery instructions and enabling the driver to time stamp each step in the delivery process. The communication devices also enable the drivers to relay information directly to the branch location if any problems or delays are encountered.

Upon delivering each parcel, the driver scans the parcel delivered, if there is an available bar code, and/or enters in a notification message into the communication device that the delivery has been made, and enters in the name of the person signing for the delivery (process segment 126). At process segment 128, the entries are automatically time-stamped and transmitted in real-time to the branch server 214 via the communication server 218 and the dispatch processor 216. The status of the deliveries is automatically updated at the dispatcher's terminal, thus enabling the dispatcher to monitor the progress of the route so that the dispatcher need only intervene when there is a problem. If a particular delivery becomes late (as measured against the preferred delivery time specified by the customer on the order), a visual and/or audible alarm will be triggered at the dispatcher's terminal to alert the dispatcher, who will then contact the driver to ascertain the cause of the delay and whether and how much of the remainder of the route may be affected. In one example of such an alarm, an icon shown on the dispatcher's screen will turn red upon detection of a late delivery time.

From the branch servers 214, both order and delivery status information is transmitted to the central database 226 at process segment 130 via extractor 222 and loader 224, whereby the central database is updated (process segment 132). The central database is used to provide information regarding the progress of all the routes to the operational staff in the local office and to the DSP's senior managers. It also provides the data to a partner web site which enables the customer and recipients to also track and monitor the progress of the deliveries (process segments 134 and 136).

If the end of the route has not been reached in process 100, process segment 138 returns the flow of process 100 to process segment 124 in which the driver proceeds to the next stop on the delivery route. As the corresponding delivery is made at each next stop, the updated delivery information is updated in the branch server 214, the central database 226, and ultimately the partner web site to be viewed in real time by the sender or its clients.

As part of the service provided to their customer, the DSP may provide a dedicated web site for the purpose of monitoring the progress of the routes, tracking deliveries and reporting on delivery usage and performance. Partner web sites may be integrated to a greater or lesser extent with the customer's own intranet and access to delivery information may also be provided through the customer's public web site. Thus, the partner web sites constitute a joint web site between the sender and the DSP.

By integrating the delivery status information into the partner web sites, both the customer and the customer's clients (the recipients) can easily monitor the progress of the delivery routes and/or track the delivery of parcels for the stop(s) relevant to the sender and/or the recipients. The customer may also be enabled to view information about its delivery costs and invoicing through the partner web sites. The pages on the partner web site are created dynamically, using data retrieved from the central database 226 and the business system database 238, by an application server 232 and served by a web server 234 to the user's browser 236 (process segment 136).

The partner web sites are preferably set up with three different access levels—a client access level, a customer service access level and a management access level. The client access level of the partner web site provides information to the customer's clients about the progress of their particular deliveries and is made available through the customer's own public web site. Alternatively clients can track their deliveries through the DSP's own web site. The customer service access level provides current and historical information about deliveries to the customer's clients with tools that make it easy for customer service personnel to track a package, check the consistency and timeliness of deliveries and the delivery history of a particular client. The management access level has all the features of the customer service level plus additional management reporting, access to cost control information and invoicing. Both the customer service access level and the management access level may be able to access route progress and other operational information.

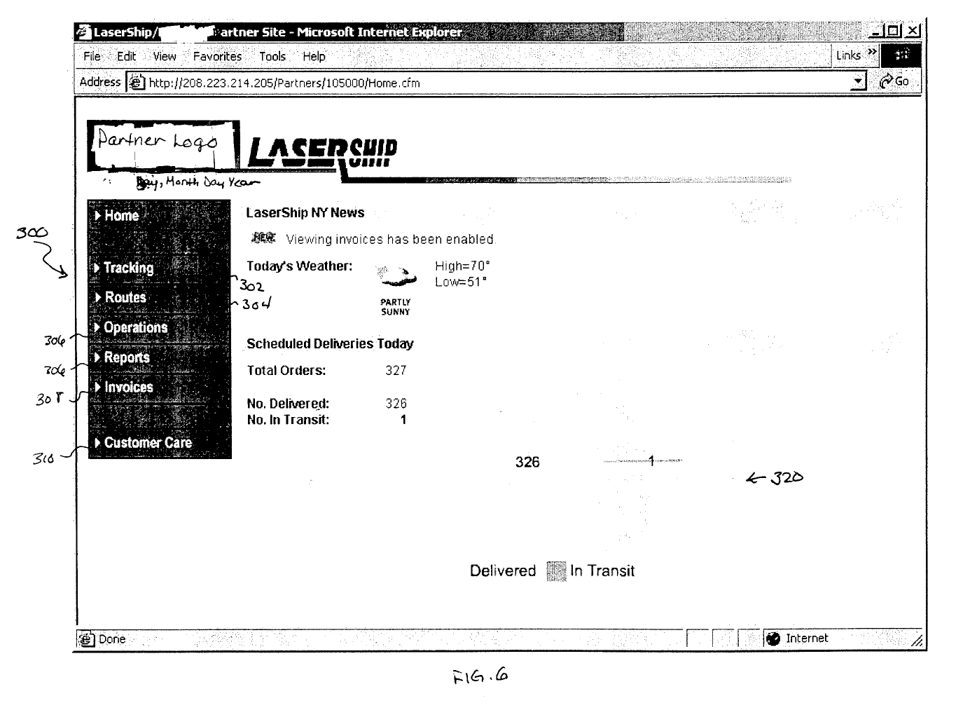

The various functions available to the sender and recipients through the partner web site will now be described below with reference to FIGS. 6-21. Upon logging into the partner web site, the user may be greeted with a screen such as that shown in FIG. 6, displaying a graph or chart 320 representing the status of deliveries scheduled for that day. If the user has the proper authority, the user may access information pertaining to the deliveries, both current and past, performed for the partner entity by selecting one of the options 302-310 in the menu bar 300.

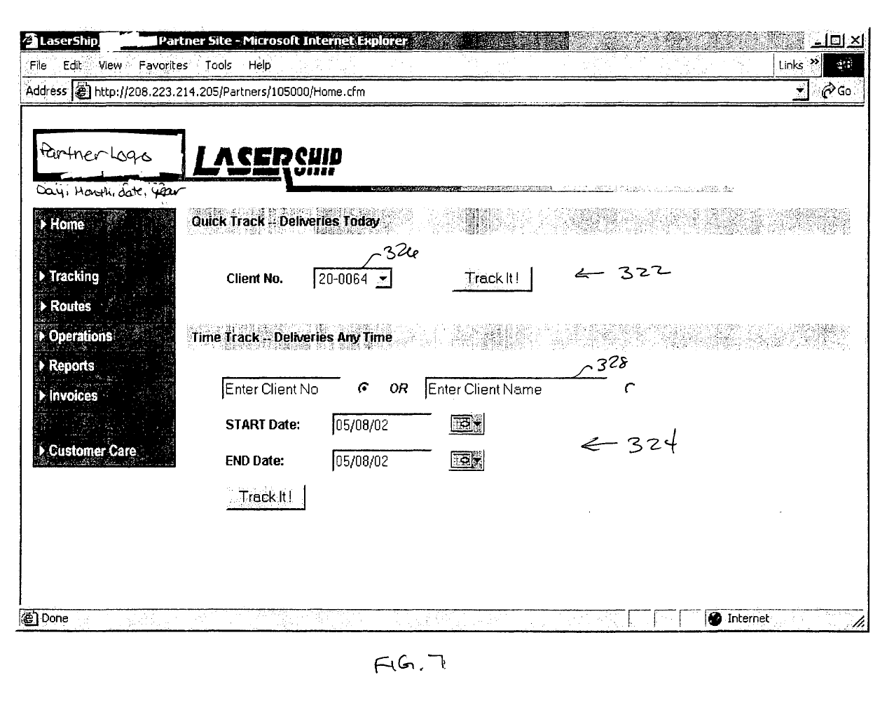

FIG. 7 shows an exemplary page of the partner web site upon selection of the “tracking” option 302 from the menu 300. As shown on this exemplary page, parcels can be tracked by viewing all parcels to be delivered that day using a quick track feature 322 based on a client number (for the parcel recipient), or by viewing all parcels scheduled to be delivered within a time frame selectable by the user 324, based on either the client number or client name. Alternatively, other options may be provided for tracking parcels, such as by the tracking number of a particular parcel, date only, quick track based on client name, etc.

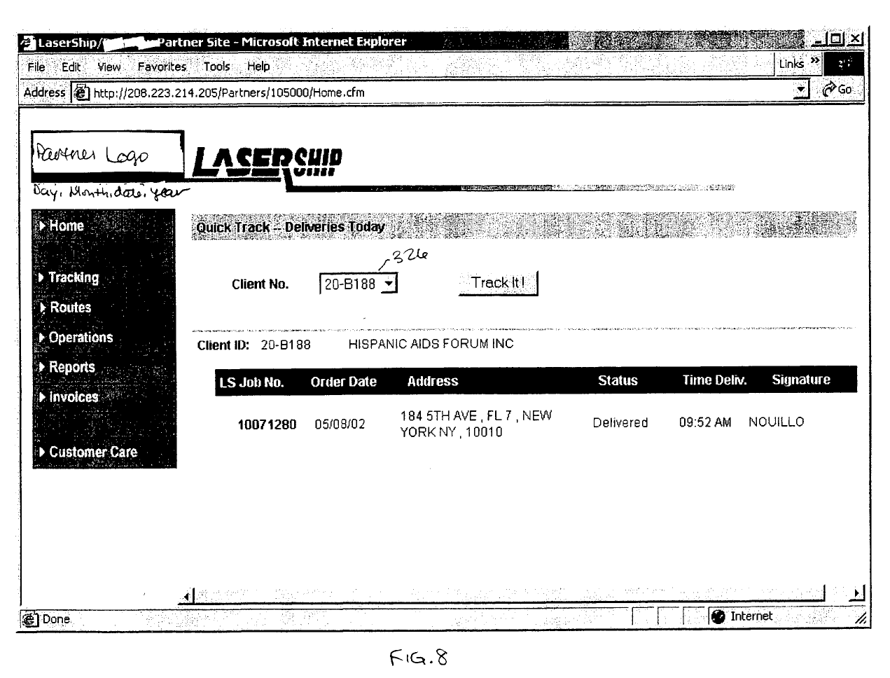

FIG. 8 shows an exemplary list of results upon using the quick track feature for the client number specified in field 326. A list of all the delivery jobs scheduled for that day is displayed, along with information such as the client name, job number, order date, delivery destination address, status of the delivery, time of delivery, name of person signing in receipt of the parcel, etc.

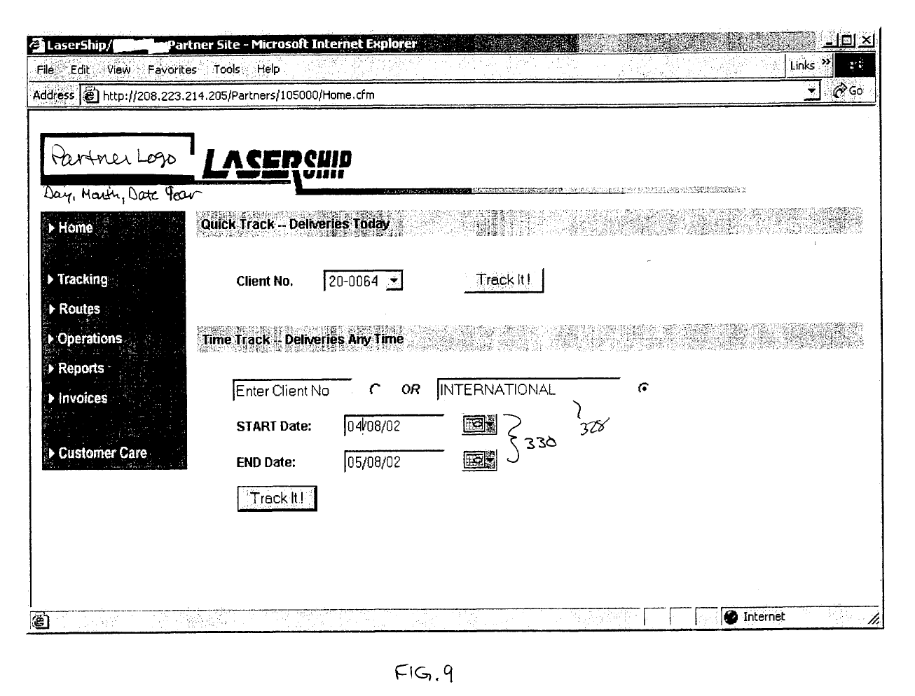

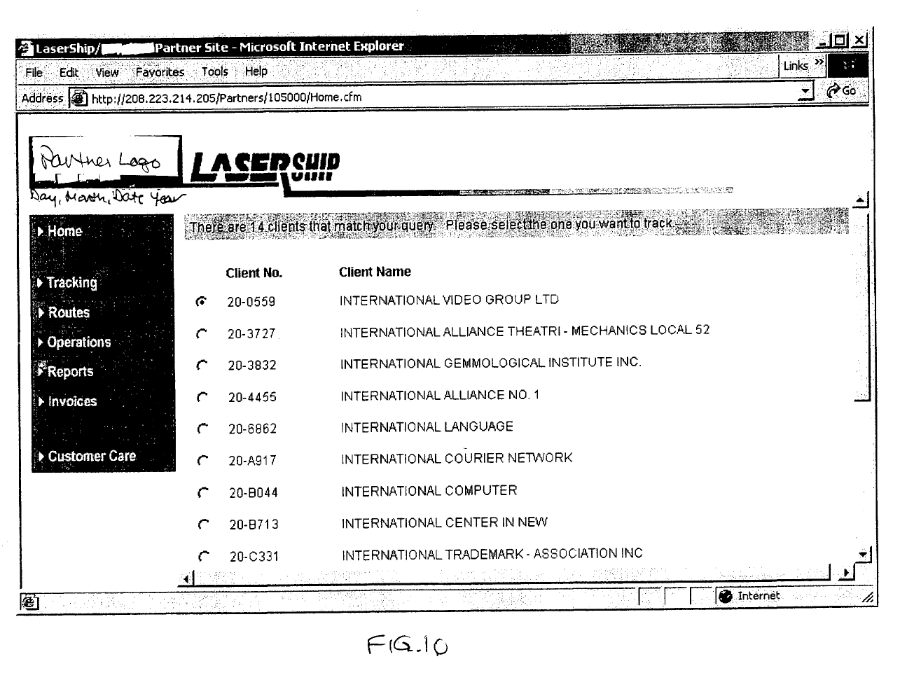

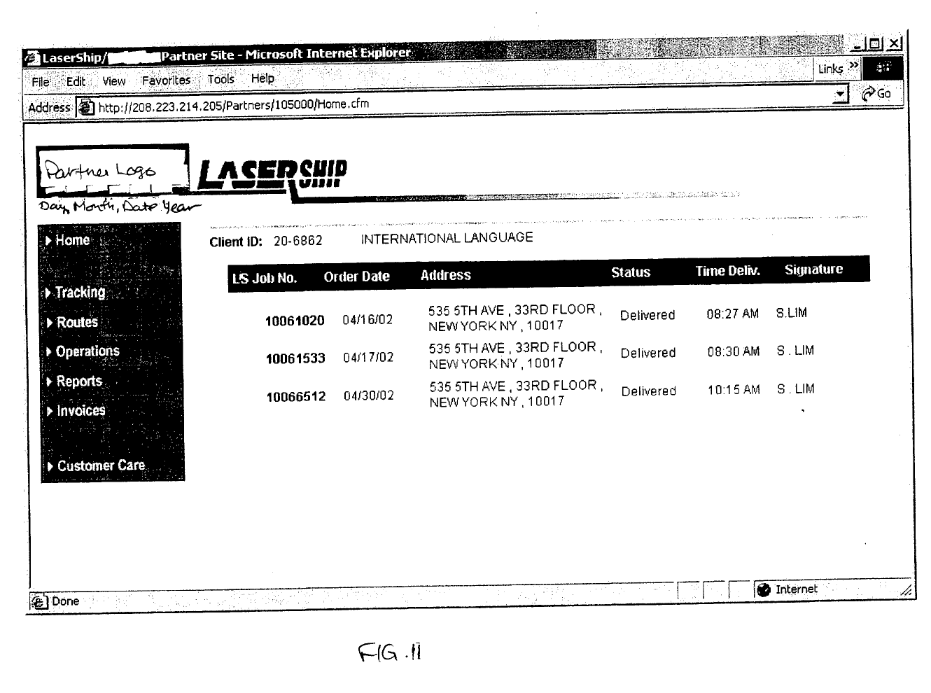

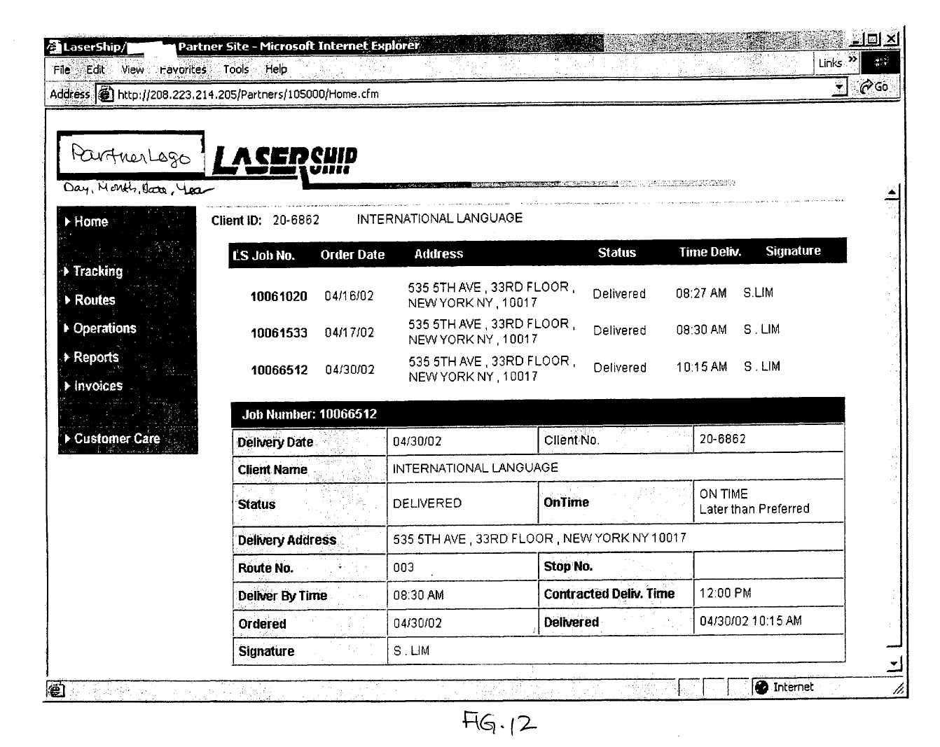

If a key word is entered into the client name field 328 as shown in FIG. 9 along with a date range using selection fields 330, an exemplary list is displayed showing all the client numbers and names having the key word in the name, among all the clients in the database and/or to which the sender has had deliveries sent (FIG. 10). Selection of one of the names from the list then yields a list of all the delivery jobs scheduled for that client in the specified time frame, as shown in FIG. 11. Selection of one of the delivery jobs will display a detailed profile of the that job, as shown in FIG. 12, including information such as the client name and number, delivery date, status of the delivery, whether or not the delivery was on time relative to the deliver by time specified by the sender, the delivery address, the route number, stop number, time of delivery, requested deliver by time, signature of person receiving the delivery, etc.

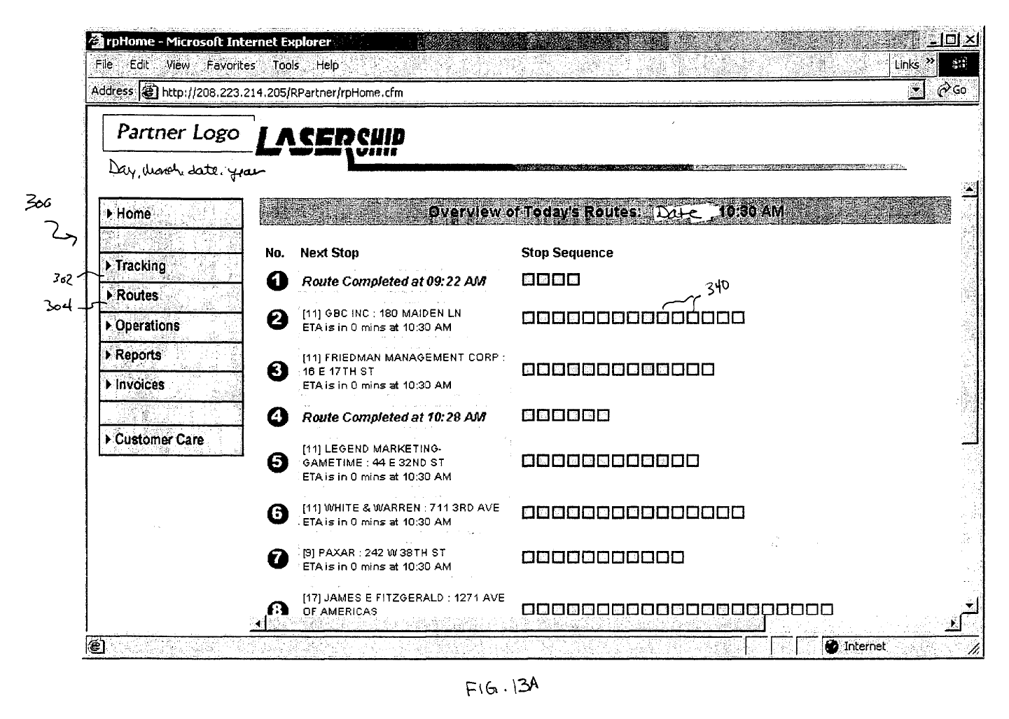

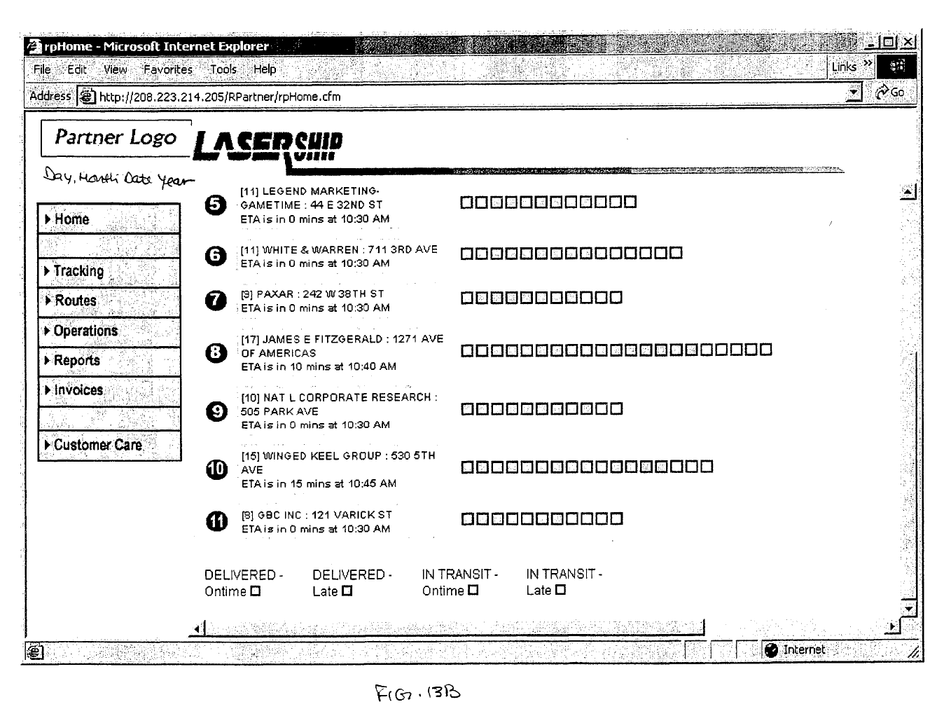

FIGS. 13A and 13B illustrate an exemplary screen which may be displayed on the partner web site upon selecting the “routes” option 302 in the menu 300. In particular, FIGS. 13A and 13B show a list of delivery routes containing stops ordered by the sender/partner site. If the route has been completed, a message to that effected is displayed next to the route number, such as that shown for routes 1 and 4 in FIG. 13A. If completion of any of the routes is still pending, the next stop along the route is identified, along with the client name, delivery address, and an estimated time of arrival (“ETA”). The ETA may be calculated based on the latitudinal and longitudinal location of the next stop relative to the last stop, actual distance to be traveled between the two stops with consideration of factors such as time of day, time of year, known construction or other traffic obstructions, etc.

In this exemplary embodiment, the stop sequence along each of the routes is represented by a symbol. Different characteristics of the symbols are shown to further indicate the status of each stop. For example, as explained by the legend shown at the bottom of FIG. 13B, symbols which are shaded indicate that the stop has been completed, while the unshaded symbols indicate stops which are still pending. A light-colored outline of the symbol indicates that the delivery time was or is projected to be on time, whereas a bold or dark-colored outline of the symbol indicates that the delivery time was or is projected to be delayed. Although not shown in FIGS. 13A-13B, the partner web site may also show the estimated time between future stops to enable the system to calculate an ETA for a selected stop further downstream in the route.

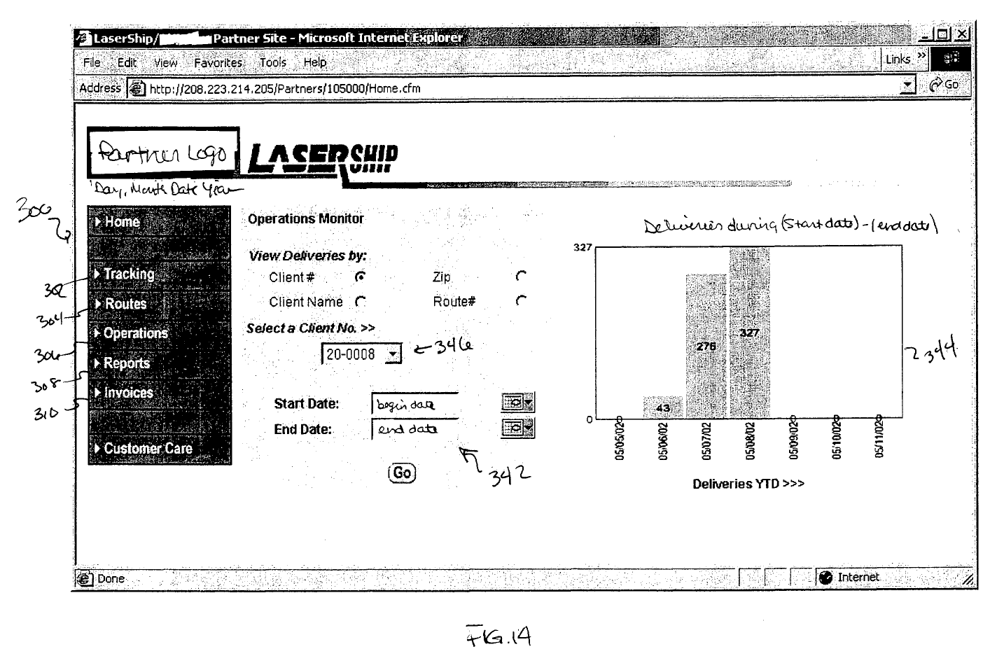

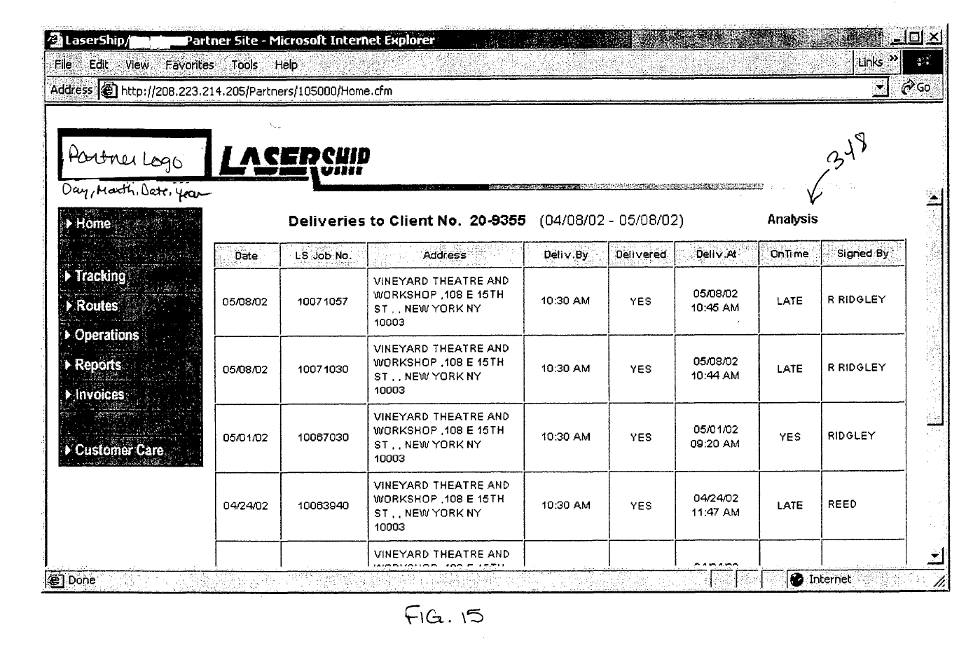

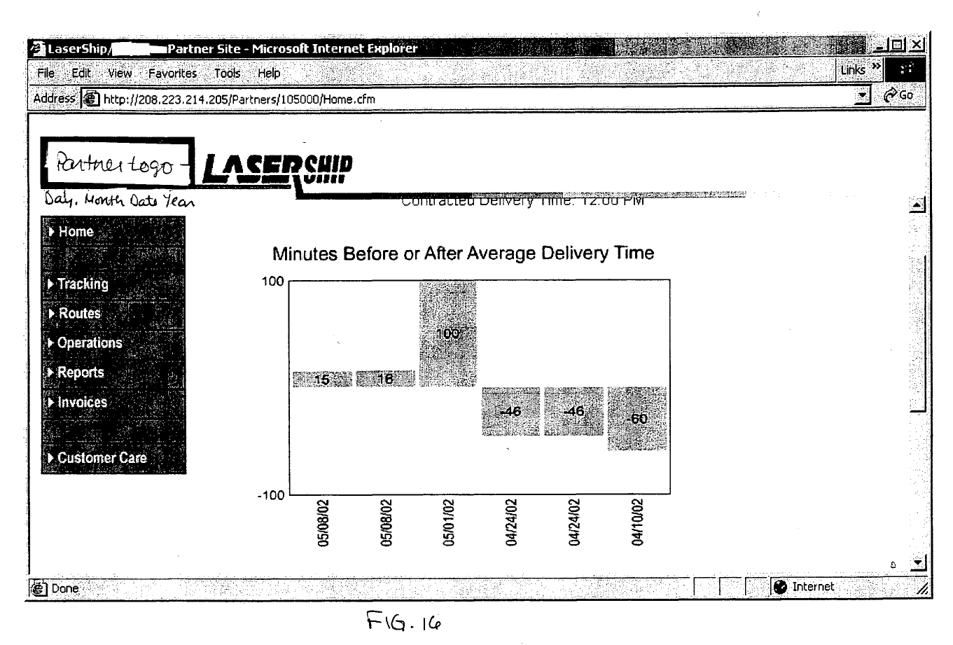

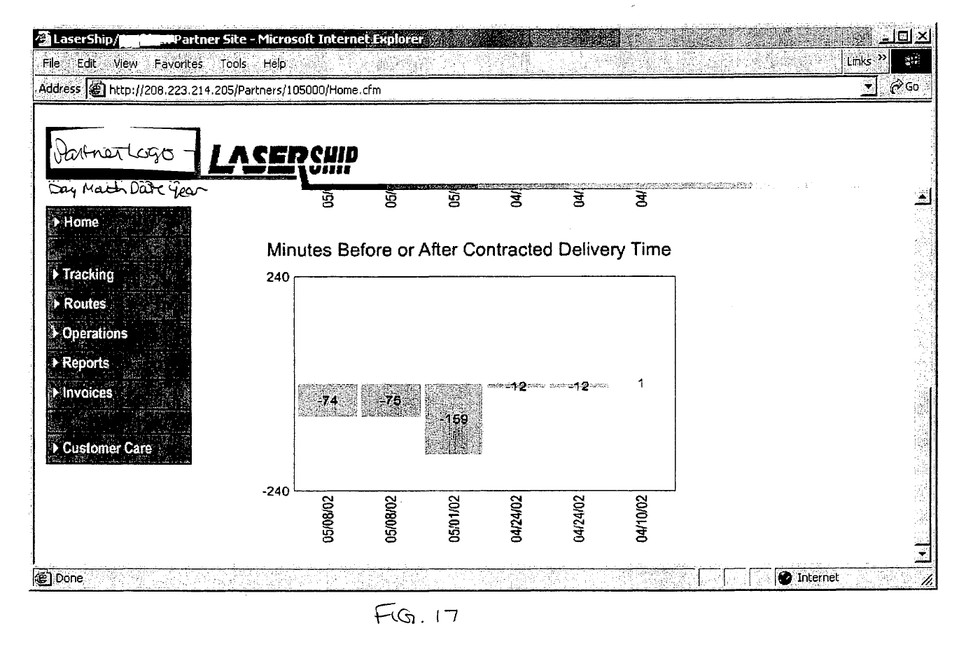

As shown in FIGS. 14-17, operational summaries may be viewed on the partner web site upon selection of the “operations” option 306 in the menu 300. For example, FIG. 14 shows a graph 344 showing the number of deliveries made during the time period specified using the pull down selection fields 342. FIG. 15 shows a chart containing information pertaining to all the deliveries made to a client number as selected in the pull down field 346 in FIG. 14, and in particular shows an analysis column 348 which indicates whether or not the listed deliveries were made on time. FIGS. 16 and 17 show graphical displays demonstrating the timeliness of the deliveries made over the specified time period.

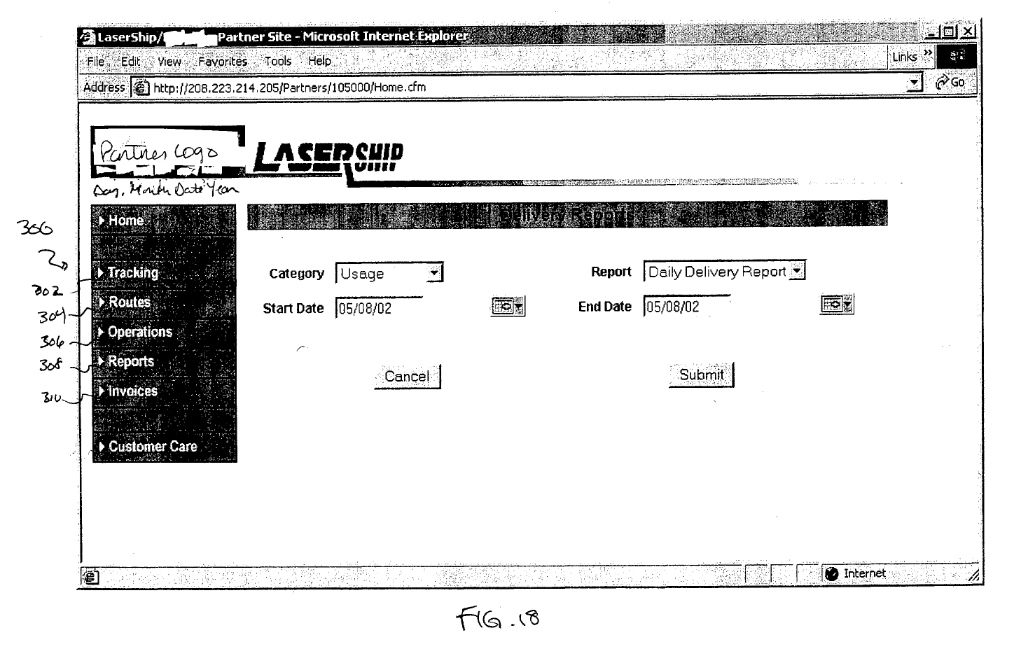

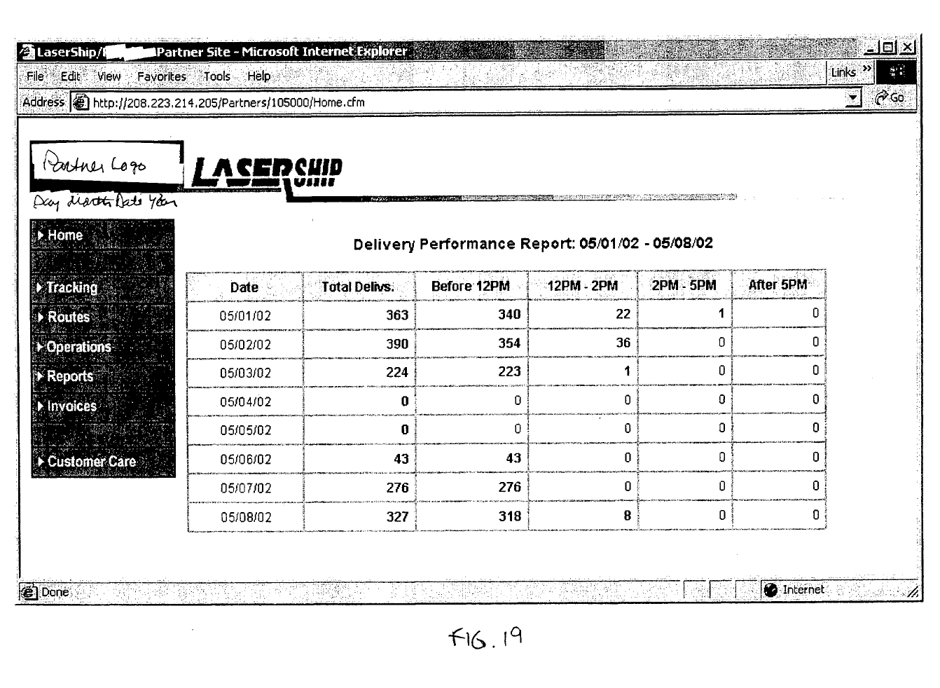

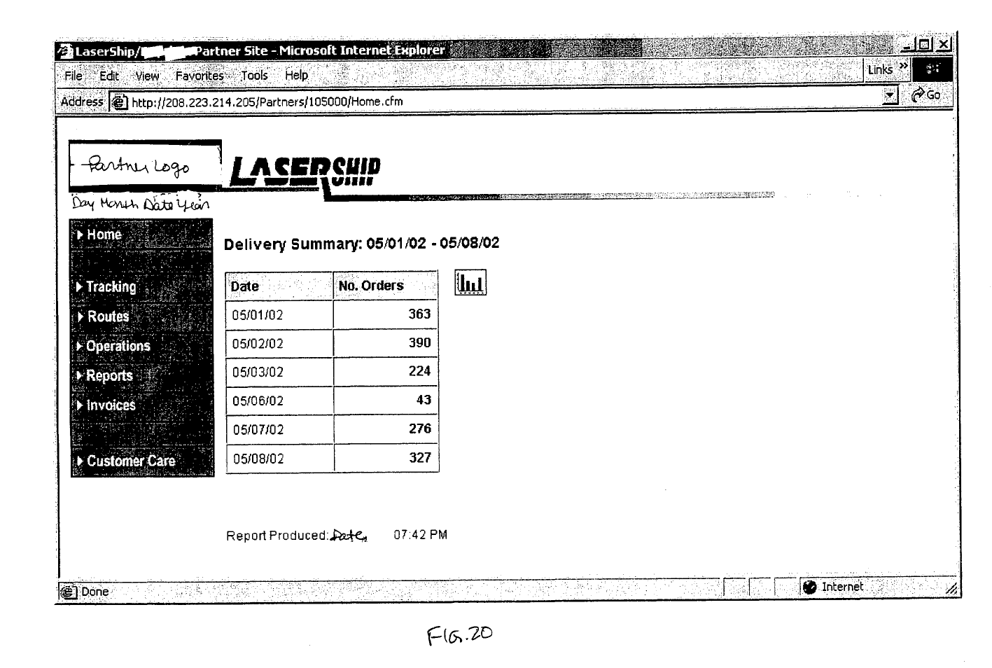

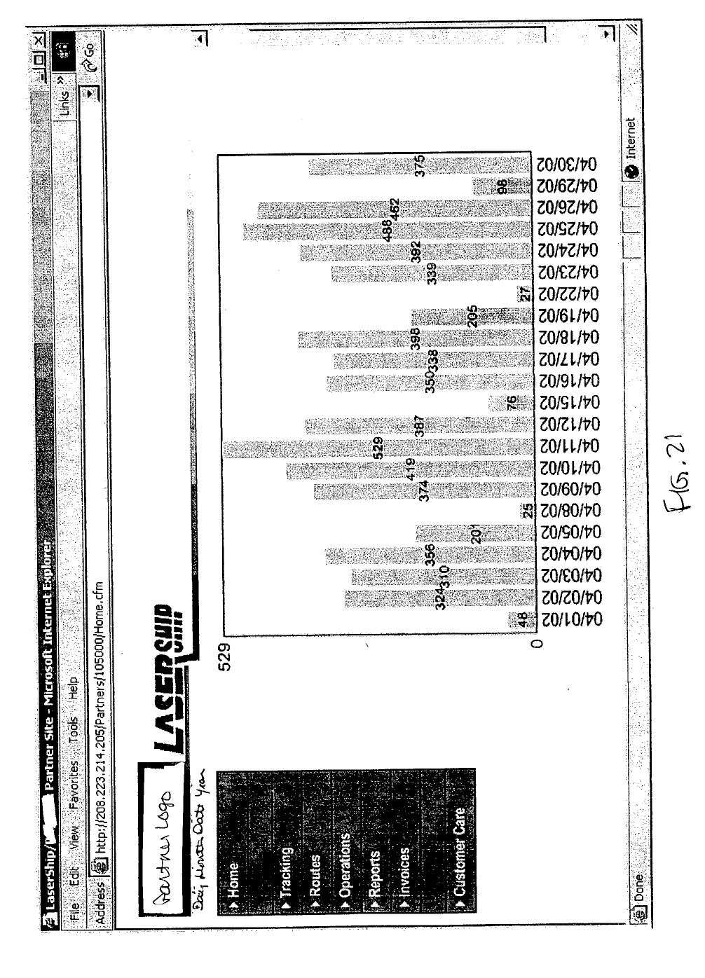

FIG. 18 shows an exemplary screen of the partner web site upon selection the “reports” option 308 in menu 300. For example, the user may select to view a daily report, a weekly report, a monthly report or an annual report. The reports may be displayed in the form of a chart, broken down by time periods of the day, as shown in FIG. 19, as a summary chart of the total number of deliveries made in the specified time period as shown in FIG. 20, as a bar graph summary of the total number of deliveries made on a daily basis over the course of a longer time frame, such as a month, as shown in FIG. 21, etc.

Upon selection of the “invoices” option 310 in the menu 300, a user with the proper authority can view accounting and invoice information for the deliveries performed for the partner entity (sender) by the DSP. Referring back to FIG. 5, the accounting information may stored in a business system database 238, managed by a business system 240, and the invoices may be prepared and maintained by invoicing system 242 using data provided by the central database 226.

The exemplary screens shown in FIGS. 6-21 are merely illustrative of the format and content which may be viewed by a user accessing the partner web site, and is by no means intended to be limiting to such exemplary views.

The same day routed delivery service according to the present invention is especially suited for time critical deliveries, repeated and/or contractual routed deliveries, and multiple deliveries of products which are too difficult or costly to package using materials and/or standards set by prior art couriers. Examples of products which may be delivered using include pharmaceutical and medical products, paychecks, any other products in which the deliveries are time critical, automotive parts and supplies, aircraft parts and supplies, bank lockboxes, etc.

Elements of the system for performing the same day routed delivery requests as exemplified above may also be used to manage other types of delivery operations, such as on-demand delivery services, semi-routed delivery services in which one driver performs all the pickup requests and another fulfills the delivery requests, and blended delivery operations in which routed delivery operations are interspersed and/or modified occasionally with on-demand jobs (thus potentially changing the delivery stops and assignments along a route in progress), regular non-expedited delivery routes, prescheduled deliveries, and customized delivery services, etc.

The key differences between same-day on-demand and same-day routed deliveries are the unpredictable nature of the deliveries to be performed each day and increased time-sensitivity of the deliveries. More specifically, same-day on-demand deliveries are ad-hoc and generally highly time sensitive with required delivery times ranging from as low as 20 minutes to 3 hours. With same-day on-demand deliveries, the itineraries of the delivery persons are defined substantially entirely by customers' orders for such time sensitive deliveries to be made as such orders are received by the DSP.

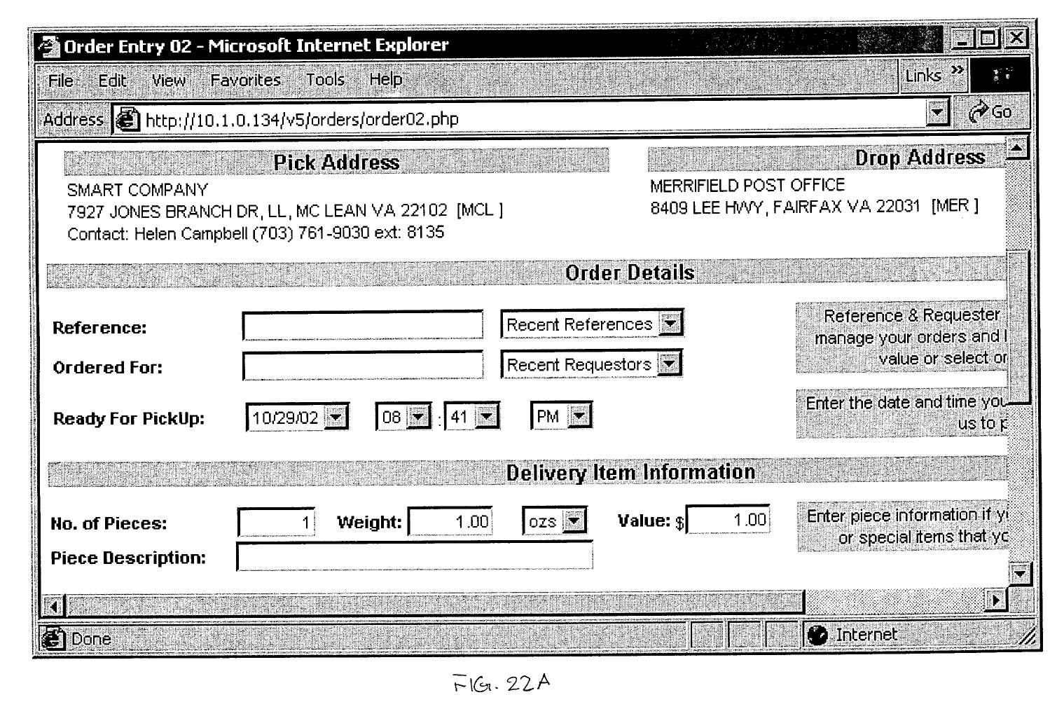

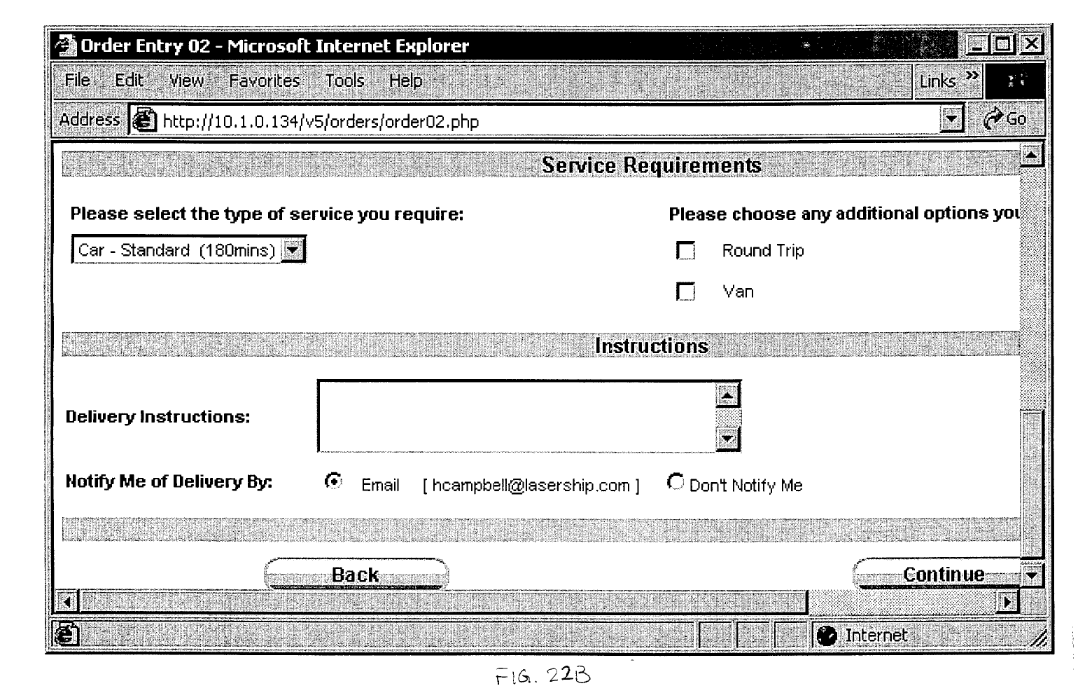

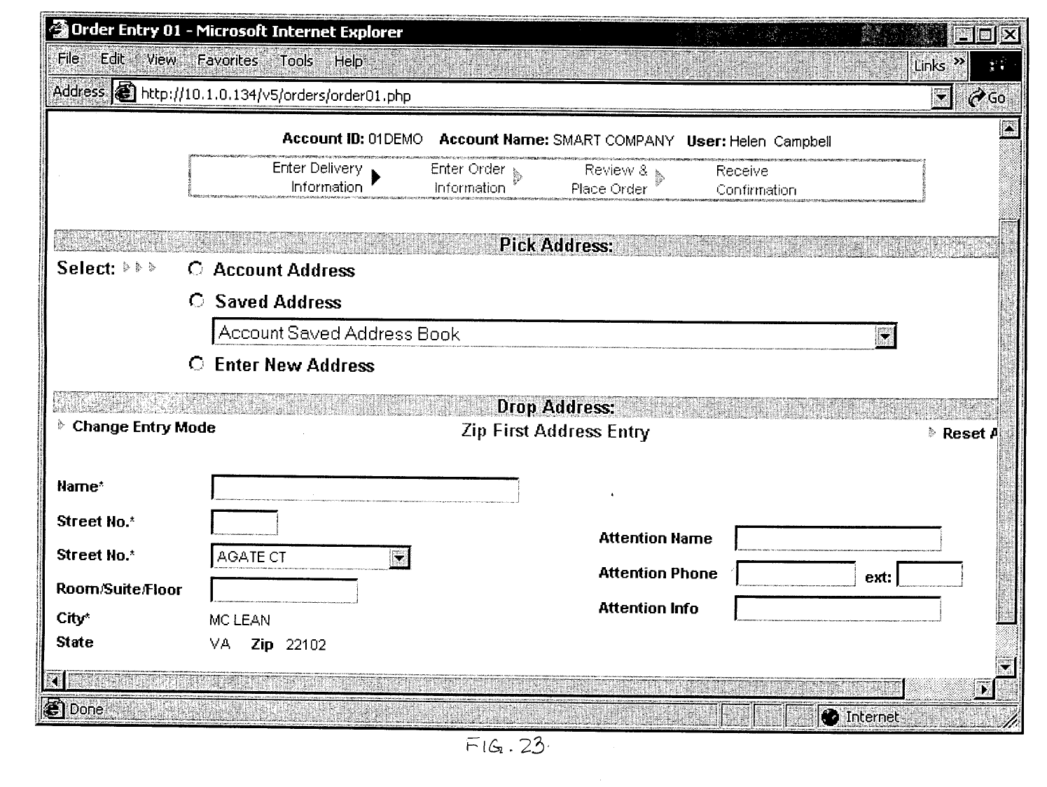

Customers requiring a same-day delivery may place an order either over the phone or through the DSP's web site, specifying the pickup and delivery address; any identifying reference code; the person on whose behalf the order was placed (i.e. the requester); the time the parcel is ready to be picked up; the customer's choice of service (which, together with the ready-by time is used to estimate the deliver by time), any special delivery instructions and who should be notified when a delivery has been made. FIG. 22A and FIG. 22B show an example of an order entry page for an on-demand delivery through the DSP's web site. FIG. 23 shows another exemplary screen shot of the order entry page into which the pickup and delivery addresses are entered.

The present invention allows for three methods by which new delivery or pickup addresses may be entered. In the first method, the zip code is entered first which automatically displays the city and state information, and may provide a pull-down list of street names within the entered zip code. In the second method, the entire address is entered, whereupon the system formats the address to be compatible with the U.S. Postal Service standards and then checks whether or not the address is recognized in the DSP system geo-database 410. In the third method, address entry is wizard enabled, wherein the system will identify partial addresses and present the user with a list of options containing the partially completed information.

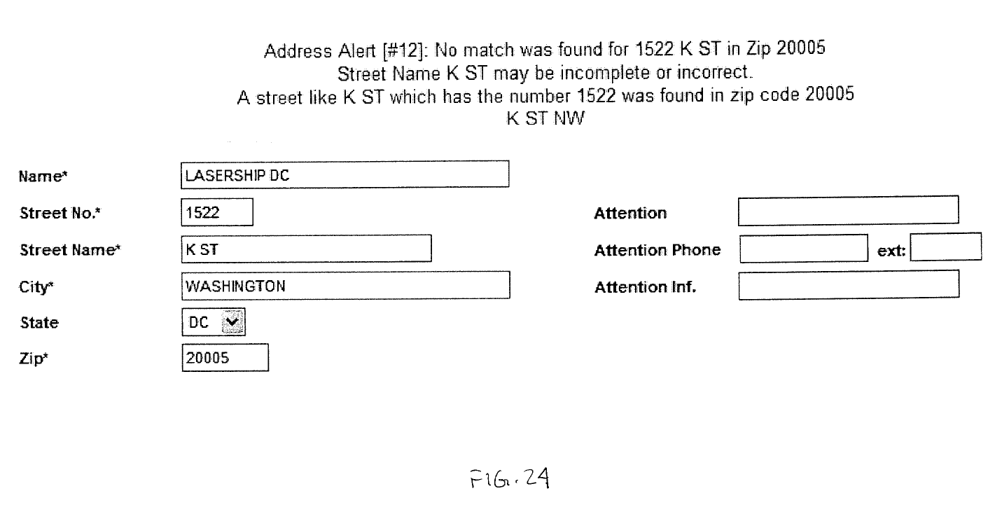

If a new address entered into the order screen of FIG. 23 using any of the three address completion methods is incomplete or incorrect, such as if a P.O. box is listed instead of a physical address, or the zip code is incorrect, or the street number does not exist or is out of range for the zip code, the DSP's address management system, together with its geo-database, is able to identify insufficient delivery addresses and to make appropriate suggestions for correcting the address (FIG. 24). If an address error is detected, an error message with suggestions for correcting the address will be displayed to the customer. Address suggestions are made using fuzzy logic applied to an extensive list of valid addresses compiled from various sources.

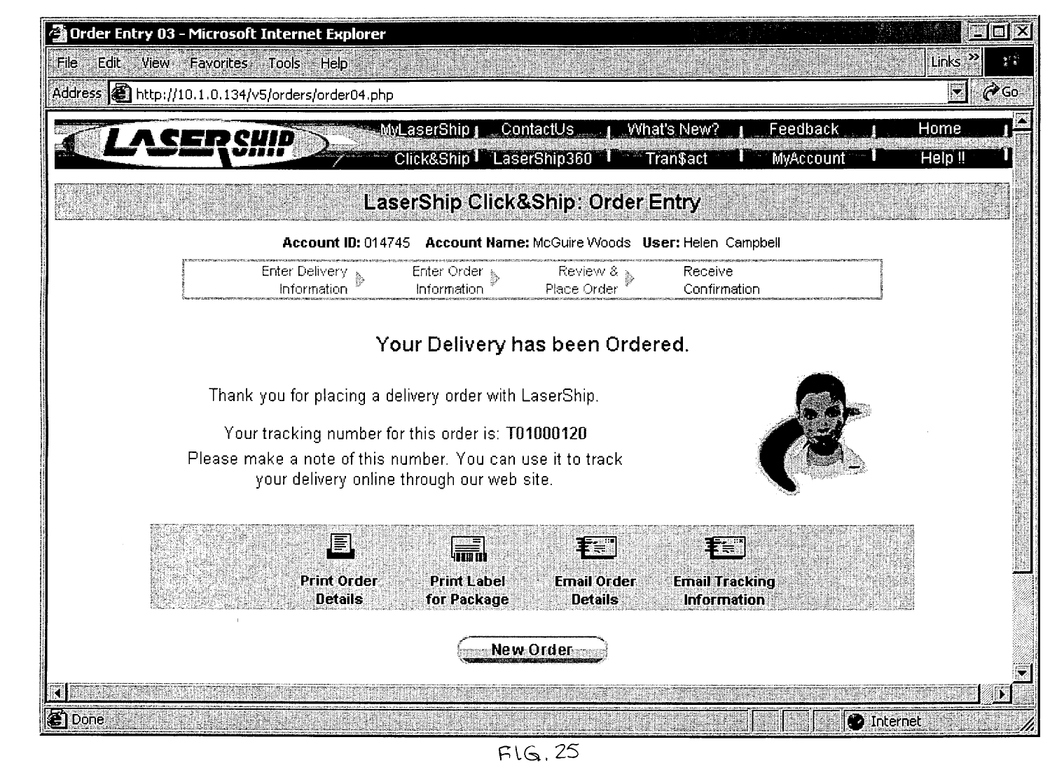

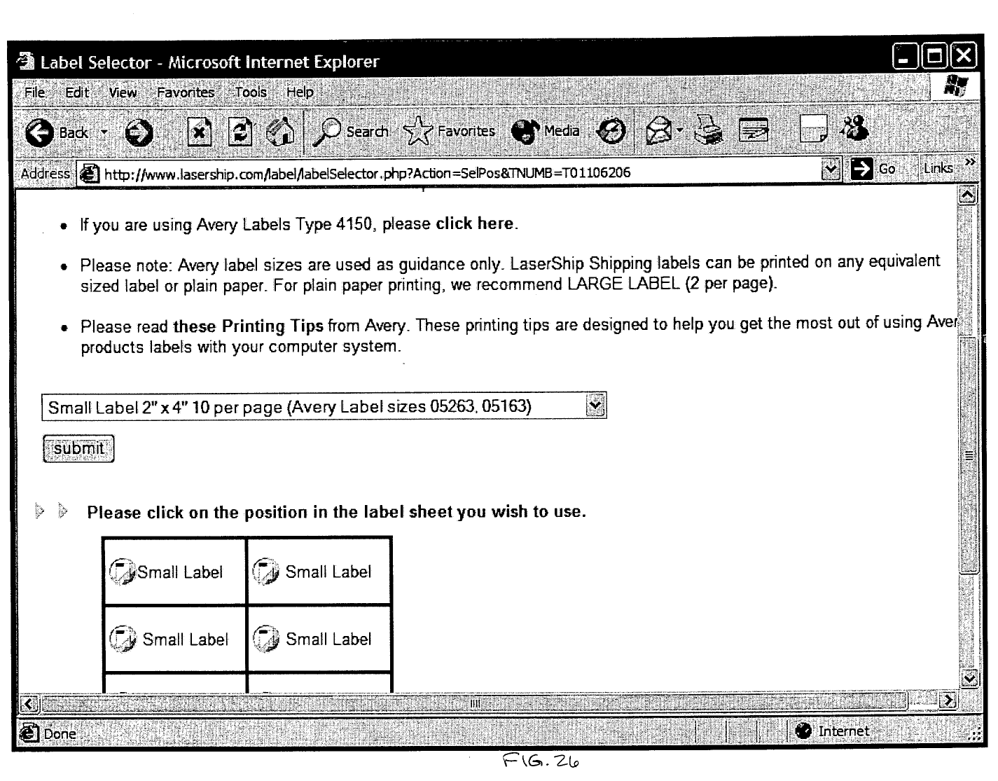

Once the user has placed the order through the DSP web site, the user is presented with options to produce a printed copy of the order, email the order information to other people, or print out labels, as shown in FIG. 25. The present invention preferably provides the user with a wide range of label generation options including labels of different sizes and the option of selecting where to place the label on a multi-label sheet (FIG. 26). Label printing is an important part of online delivery ordering as it saves the customer time, ensures that the correct information is on the package, and helps to validate the security of the package.

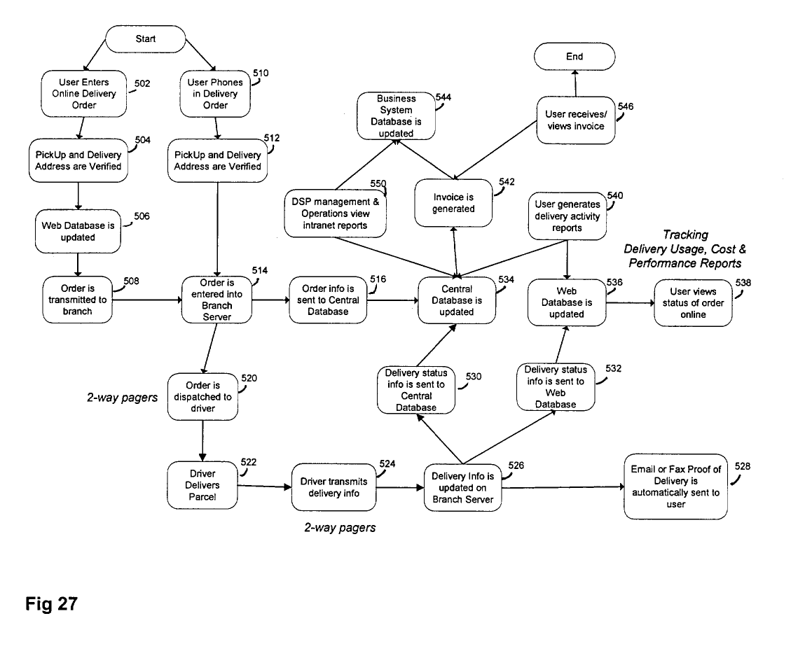

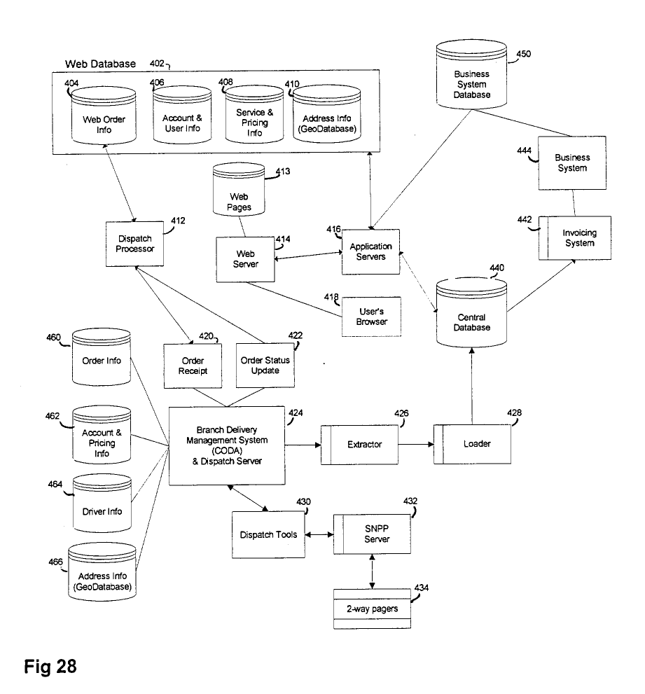

A process for managing and operating same-day on-demand deliveries in accordance with a second aspect of the present invention is outlined in FIG. 27, and the system used to support the process is shown in FIG. 28. In the process 500 of FIG. 27, a user may place an order for same-day on-demand delivery either through the DSP's web site at process segment 502, or over the telephone, at process segment 510. The DSP's web database 402 includes an address database 410 and service and pricing database 408 to facilitate a user in placing an order. In particular, the address database 410 assists the user in entering correct pickup and delivery addresses (process segment 504, 512). When an order is placed through the DSP web site, a dispatch processor 412 determines which branch will receive the order (process segment 506). The dispatch processor 412 takes key information from the online order and creates appropriate entries for the order in the account and user database 406 and in the web order database 404 (process segment 506). The dispatch processor 412 then repackages the order information and transfers it to the designated branch delivery management system 424 (branch server) (process segment 508).

If the order is successfully received by the branch server 424, the order receipt module 420 issues an acknowledgement to the dispatch processor 412 and the delivery order is placed on the dispatch pending board (process segment 514). If the dispatch processor 412 does not receive an acknowledgement within a defined period of time (typically 1 min), the dispatch processor 412 detects the failure to receive the acknowledgement signal as an indication that the order has failed to reach the designated branch server 424, whereupon an alarm is generated which results in emails/text messages being automatically sent to key individuals e.g. the branch manager, IT support. If the order has been received by the branch server 424 but the dispatcher fails to assign the job within a specified period of time, further alarms are generated. Similarly, alarms will be triggered if the job is not picked up or delivered within accepted periods of time. In each case, the set of individuals to be notified and the manner by which they are notified (text messaging, email or fax) can be modified by the appropriate personnel as necessary. In this way, same-day on-demand delivery orders placed online can be automatically monitored from the moment of entry all the way through to delivery. Without this safeguard mechanism, orders can be easily ‘lost,’ causing users to lose confidence in the efficacy of the system.

All inbound orders received by the branch server 424 are placed on a dispatch pending board and are viewable by the branch dispatcher through the dispatch tools system 430 on his or terminal. The dispatcher assigns the delivery to a particular driver at process segment 520, using the driver information stored by the driver database 404 connected to the branch server 424. The details of the delivery are transmitted to the courier using the DSP's wireless 2-way messaging devices 434 via messaging server 432 (SNPP system). As soon as the courier views the text-message, an acknowledgement is transmitted back to the DSP's SNPP system 432 and hence to the dispatcher. When the courier picks up the parcel, he or she alerts the dispatcher by selecting “Picked Up” from a menu of pre-defined text messages on his or her messaging device 434. The event is date and time stamped and the DSP's SNPP system 432 interfaces with the branch server 424 to update the status of the job. Similarly, when the courier delivers the parcel at process segment 522, he or she selects the option “Delivered” from the menu of pre-defined text messages at process segment 524. In addition, the courier also transmits the name of the recipient of the parcel (process segment 522). This information is transmitted back to the DPS's branch server 424 at process segment 526, whereupon the order status is also updated to the dispatch processor 412 via the order status update module 422, and ultimately to the web database 402 at process segments 532, 536. Upon receiving notice that the delivery has been completed, the job is closed out from the dispatch board and the order is updated both at the branch server 424 and the central database 440 (via extractor 426 and loader 428) (process segments 530, 532.

When the order has been delivered, it triggers a Proof of Delivery (POD) notification at process segment 528. POD notifications can be sent to the user and a number of other designated parties. User POD notifications can be sent by email or fax. Third-party POD notifications are sent by email.

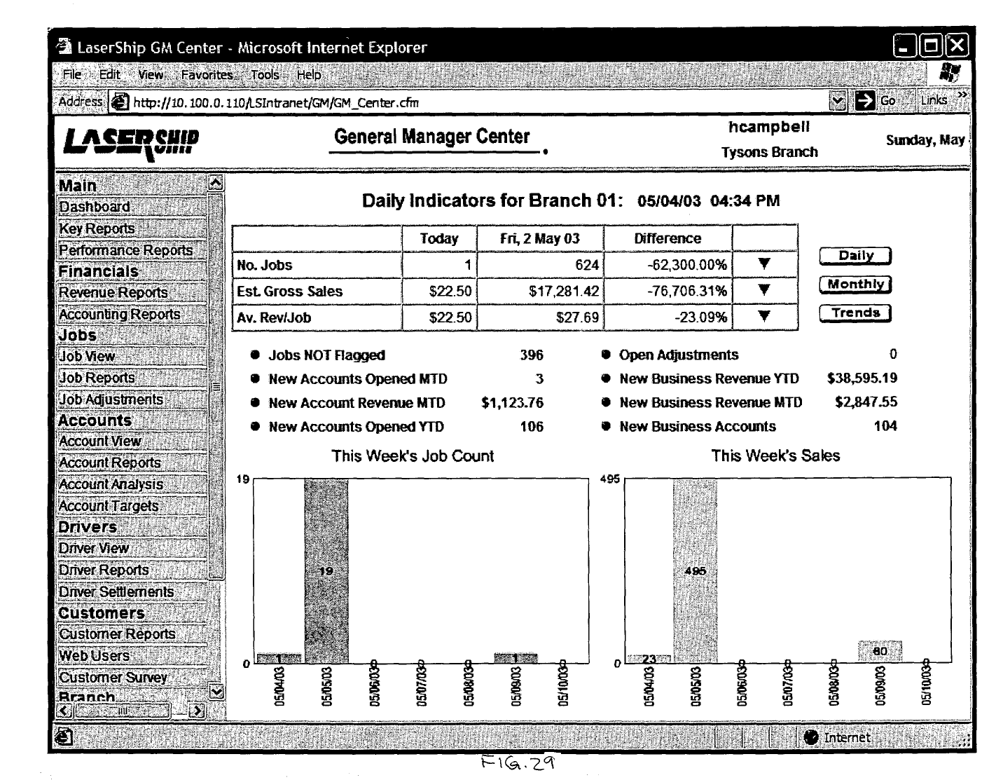

As discussed above, the dispatch processor 412 not only manages the transfer of orders to the branch, it also receives delivery status information entered into the branch server 424, either directly or through the dispatch tools software 430, via the order status update module 422 to update the web database 402. Any order information or delivery status updates are also automatically transferred to the central database 440 via process segments 516, 534. Central database 440 generates invoices via the invoicing system 442 at process segment 542. Receivables information for each invoice is integrated into the business systems database 450 at process segment 544 by the business system 444 which also provides accounting information and financial reports. Invoice, order, account, revenue, cost and other management information are viewable to authorized DSP personnel through the DSP's intranet at process segment 550 via an intranet portion of application server 416. An example of a business report viewable through the DSP intranet is shown in FIG. 29. Together with the web database 402, central database 440 also enables a user to track, monitor and view reports of the delivery information on the DSP's web site (process segment 536). The publicly accessible web site provided by the DSP is available to customers through their web browsers 418 for placing orders online, tracking packages, monitoring deliveries, running reports on delivery usage and costs, viewing invoices and managing information associated with online usage including saved addresses and rapid order entry profiles (e.g. “1-Click”). This DSP web site is powered by a web server 414 in connection with web pages 413 and one or more internet portion of application server 416.

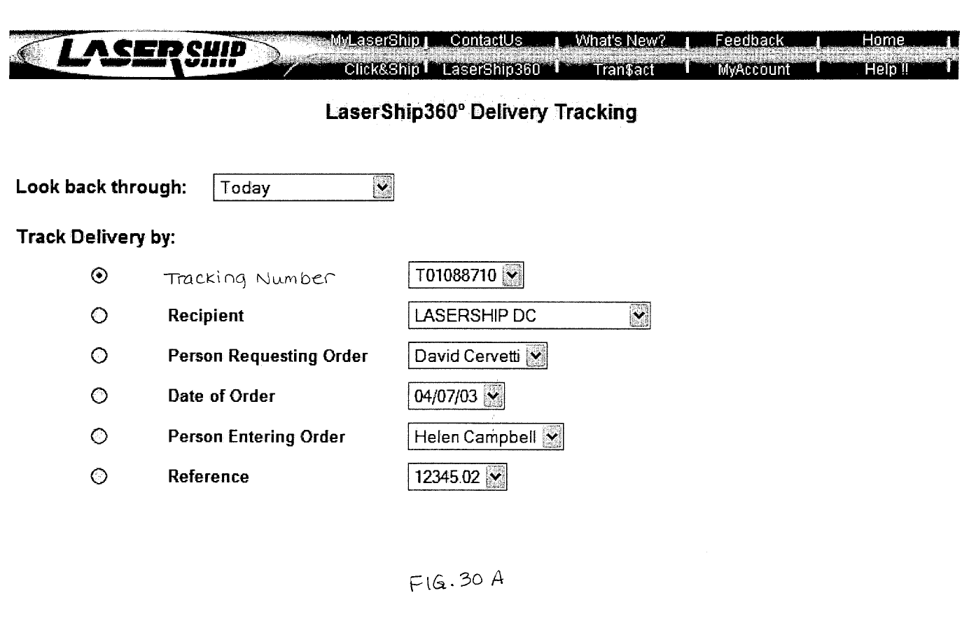

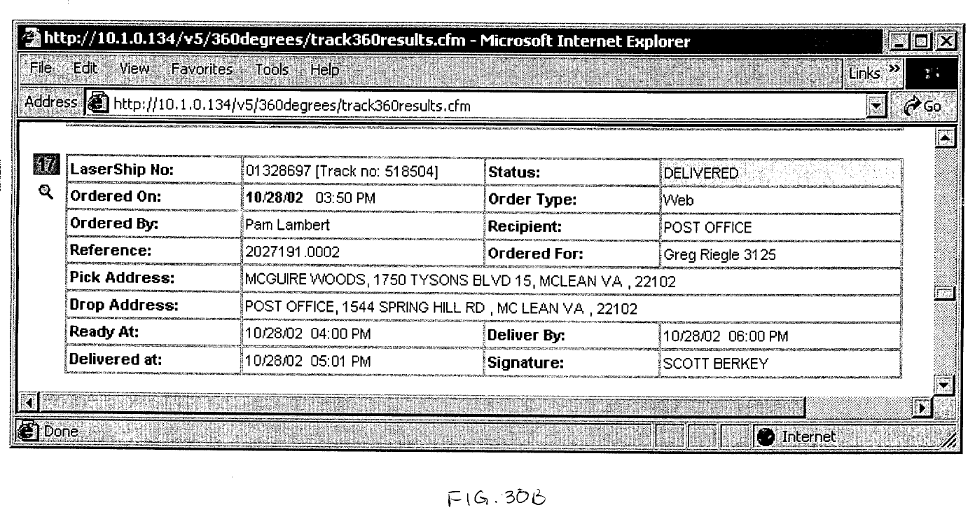

Examples of the tracking features provided by the web site are shown in FIG. 30A and FIG. 30B. Unlike conventional online delivery tracking systems, the present invention does not require the input of a DSP assigned tracking number, and can track deliveries by order date, recipient, requester, reference number and user. Selection is made easier by presenting possible options in a series of drop down menus (FIG. 30A).

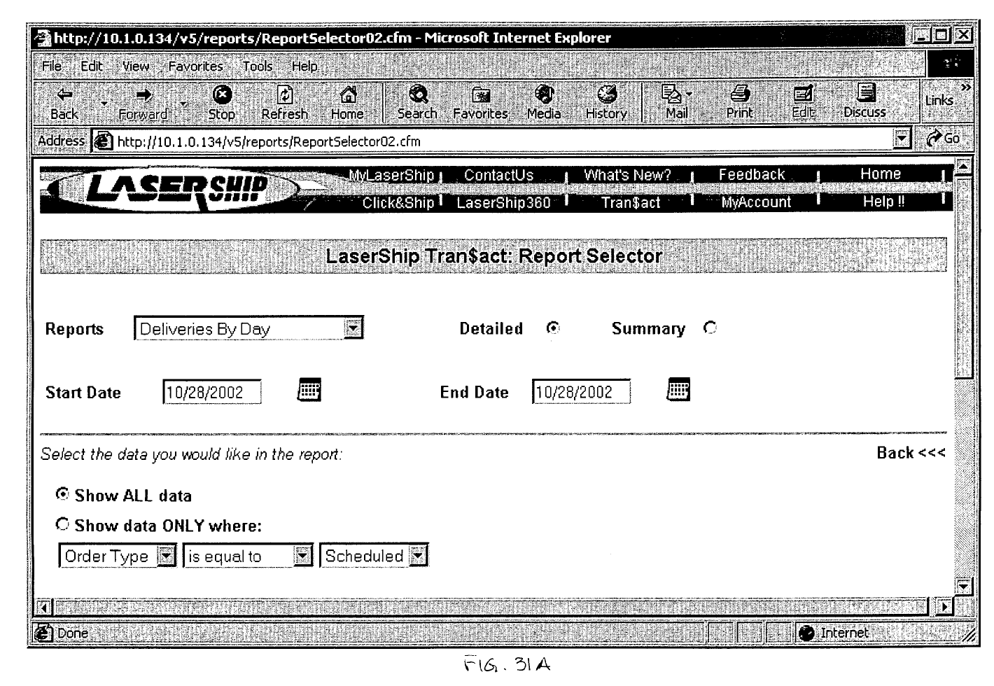

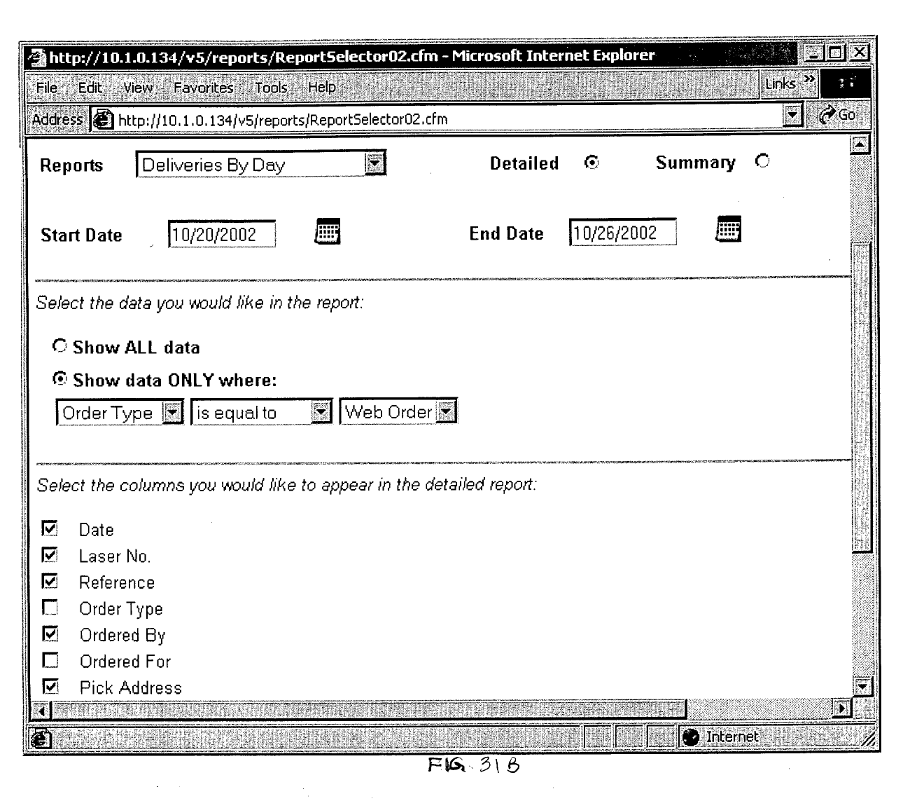

The web site also provides a wide range of reporting options. Users can select from a variety of pre-designed reports, both summary or detailed, or design their own reports by selecting both filters and displayable fields (FIGS. 31A-31B). Users are also provided with cost information through specially designed reports, and the ability to view their invoices online. Online invoicing is made possible by the integration of business system information held in the business system database 450 (FIG. 28).

The processes and systems described above illustrate preferred methods and representative systems of which many variations and modifications thereof could be used and produced. The above description and drawings illustrate embodiments which achieve the objects, features, and advantages of the present invention. However, it is not intended that the present invention be strictly limited to the above-described and illustrated embodiments. Any modifications, though presently unforeseeable, of the present invention that comes within the spirit and scope of the following claims should be considered part of the present invention.

What is claimed as new and desired to be protected by Letters Patent of the united states is:

1. A method of delivering parcels to a plurality of locations comprising:
receiving a plurality of parcels to be delivered as a same-day routed delivery job;
receiving a manifest containing a plurality of sets of recipient information, the number of sets corresponding with the number of parcels; and
providing at least one optimized route for delivering the parcels, each route containing at least two stops arranged in a designated order and travel directions for traveling from each stop to the next stop.

2. The method according to claim 1, further comprising
automatically assigning and dispatching each route, associated parcels and recipient information to a delivery person.

3. The method according to claim 1, further comprising:
dispatching each route, associated parcels and recipient information to a delivery person;
delivering the parcels according to the stop sequence generated for each route; and
upon delivering each parcel, providing an electronic update notice regarding the progress of delivery along each route in real time.

4. The method according to claim 3, further comprising:
displaying information representing the progress of delivery along each route including at least one of an estimated time of delivery for the next pending stop in each route and an estimated time between consecutive pending stops along each route; and
updating the displayed information in real time to reflect the electronic updates provided upon the delivery of each parcel.

5. The method according to claim 4, wherein displaying the route progress information includes representing each stop along the route with a symbol and representing the status of each stop with different characteristics of the respective symbol.

6. The method according to claim 1, further comprising:
dispatching each route, associated parcels and recipient information to a delivery person; and
delivering the parcels according to the stop sequence generated for each route,
wherein all of the parcels to be delivered along each route are delivered within one day.

7. A method of delivering parcels to a plurality of locations comprising:
receiving a plurality of parcels to be delivered as a same-day delivery job;
electronically matching recipient information for each parcel to corresponding address information in a database; and
providing at least one optimized route for delivering the parcels, each route containing at least two stops arranged in a designated order and travel directions for traveling from each stop to the next stop.

8. The method according to claim 7, further comprising automatically assigning and dispatching each route, associated parcels and recipient information to a delivery person.

9. The method according to claim 7, further comprising:
dispatching each route, associated parcels and recipient information to a delivery person;
delivering the parcels according to the stop sequence generated for each route; and
upon delivering each parcel, providing an electronic update notice regarding the progress of delivery along each route in real time.

10. A method of delivering parcels to a plurality of locations comprising:
receiving a plurality of parcels to be delivered as a same-day delivery job;
electronically matching recipient information for each parcel to corresponding address information in a database;
automatically creating a delivery order for each parcel upon matching the recipient information to corresponding address information; and
providing at least one optimized route for delivering the parcels, each route containing at least two stops arranged in a designated order and travel directions for traveling from each stop to the next stop.

11. The method according to claim 10, further comprising
automatically assigning and dispatching each route, associated parcels and recipient information to a delivery person.

12. The method according to claim 10, further comprising:
dispatching each route, associated parcels and recipient information to a delivery person;
delivering the parcels according to the stop sequence generated for each route; and
upon delivering each parcel, providing an electronic update notice regarding the progress of delivery along each route in real time.

13. A method for delivering parcels comprising:
receiving from a sender an electronic order for same-day delivery of a parcel to a recipient, wherein the order contains address information for the recipient;
transmitting the order to an appropriate branch location; and
generating an alarm if an acknowledgement signal is not received from the branch location acknowledging the order transmission within a predetermined amount of time.

14. The method according to claim 13, further comprising:
if an acknowledgement signal is received from the branch location acknowledging the order transmission within the predetermined amount of time;
dispatching the order to a courier.

15. The method according to claim 14, further comprising:
if an acknowledgement signal is not received from the courier acknowledging receipt of the dispatched order, generating an alarm.

16. The method according to claim 13, further comprising automatically detecting an error in the address entered into the order and providing suggestions for correcting the error.

17. A system for managing delivery of parcels comprising:
a pre-populated address database;
an order entry module for generating electronic orders by associating client information on a parcel with at least one delivery address stored in the database;
a server for managing a routed delivery of a plurality of parcels along an optimized route; and
an automatic dispatcher for dispatching an optimized delivery route information and delivery information to a delivery person, wherein the route information includes at least two stops arranged in a designated order and travel directions for traveling from each stop to the next stop.

18. The system according to claim 17, further comprising:
a wireless communication device for each delivery person, the wireless communication device in real time communication with the server for providing real time updates of route progress and delivery status information.

19. The system according to claim 17, further comprising a web server for displaying information representing the delivery status of each of pending route, wherein the web server enables the displayed information to be updated in real time.

20. The system according to claim 17, further comprising a web server for providing access to a web site for tracking the delivery status of parcels scheduled to be delivered along the generated routes in real time, and for monitoring the progress of the generated routes.

21. The system according to claim 20, wherein the web site has at least two different levels of secure access.

22. The system according to claim 21, wherein one level of access provides access to clients designated as recipients of the parcels scheduled to be delivered along the generated routes.

23. The system according to claim 22, wherein another level of access provides access to a sender for tracking the progress of deliveries along the generated routes and for managing delivery operations.

24. The system according to claim 17, wherein the server is a branch server, and the branch server is one of a plurality of branch servers each managing delivery of parcels along generated routes which are respectively assigned to each branch server.

25. A system for managing a same-day on-demand delivery order, comprising:
a host server for receiving electronic delivery orders placed through a host site;
a dispatch processor for routing the order to an appropriate branch server location for handling the delivery;
a order receipt module for transmitting an acknowledgement signal to the dispatch processor upon receiving an order therefrom; and
a branch server for managing the delivery of the order.

26. The system according to claim 25, further comprising:
a wireless communication device for a delivery person performing the delivery, the wireless communication device in real time communication with the server for providing real time updates of route progress and delivery status information.

27. The system according to claim 25, further comprising a web server for displaying information representing the delivery status of each of pending route, wherein the web server enables the displayed information to be updated in real time.

28. The system according to claim 25, further comprising a web server for providing access to a web site for tracking the delivery status of parcels scheduled to be delivered along the generated routes in real time, and for monitoring the progress of the generated routes.
